(19) United States
(12) Patent Application Publication
(10) Pub. No.: US 2015/0166029 A1
(43) Pub. Date: Jun. 18, 2015

(54) VEHICLE BRAKE DEVICE

(71) Applicants: Tsuyoshi Yamasaki, Toyota-shi (JP); Masayasu Ohkubo, Okazaki-shi (JP)

(72) Inventors: Tsuyoshi Yamasaki, Toyota-shi (JP); Masayasu Ohkubo, Okazaki-shi (JP)

(73) Assignee: TOYOTA JIDOSHA KABUSHIKI KAISHA, Aichi (JP)

(21) Appl. No.: 14/390,537

(22) PCT Filed: Apr. 4, 2012
(86) PCT No.: PCT/JP2012/059252

§ 371 Date: Oct. 3, 2014

(51) Int. Cl. B60T 13/16; B60T 8/17; B60T 13/58

(52) U.S. Cl. CPC B60T 13/167; B60T 13/58; B60T 8/17

(57) ABSTRACT

A separation valve mechanism includes a housing, and a stepped piston fitted into the housing in a liquid-tight and slidable manner and serving as a separation piston. A large diameter chamber is provided on a large diameter side of the stepped piston, and a small diameter chamber is provided on a small diameter side thereof. A first seal member is provided on the small diameter side of the stepped piston so as to secure liquid tightness of the small diameter chamber and partition the small diameter chamber. A second seal member is provided on the large diameter side of the stepped piston so as to secure liquid tightness of the large diameter chamber and partition the large diameter chamber. A reservoir chamber is formed, which is adjacent to the small diameter chamber and the large diameter chamber, and is partitioned by the first seal member and the second seal member. A master cylinder pressure is not input to the reservoir chamber.

### TECHNICAL FIELD

The present invention relates to a vehicle brake device including a wheel cylinder for receiving a hydraulic pressure of a working fluid and applying a braking force to a wheel, a master cylinder for generating a hydraulic pressure in response to an operation by a driver on a brake pedal, and outputting the hydraulic pressure via a plurality of systems, a power hydraulic pressure source for generating a hydraulic pressure through drive of a pressurizing pump, a linear control valve for adjusting the hydraulic pressure transmitted from the power hydraulic pressure source to the wheel cylinder, hydraulic pressure detection means for detecting a hydraulic pressure output from at least one of the plurality of systems of the master cylinder, and control means for controlling drive of the linear control valve based on the hydraulic pressure detected by the hydraulic pressure detection means.

### BACKGROUND ART

In recent years, there has been proposed a brake device including a pressurizing pump, a pressure increasing linear control valve, and a pressure decreasing linear control valve, and configured to set a target hydraulic pressure for a wheel cylinder corresponding to a hydraulic pressure generated in a master cylinder in response to a driver's operation of depressing a brake pedal, and drive the pressure increasing linear control valve and the pressure decreasing linear control valve, to thereby supply the hydraulic pressure increased by the pressurizing pump so that the hydraulic pressure follows the set target hydraulic pressure of the wheel cylinder. Then, as the brake device of this type, brake systems disclosed in Patent Literatures 1 and 2 have hitherto been known. In the related-art brake systems, for example, if an abnormality occurs in an electric system, operations of the pressurizing pump, the pressure increasing linear control valve, and the pressure decreasing linear control valve are stopped. Then, a pressure increasing mechanism is operated by the hydraulic pressure of the master cylinder, and the servo pressure is directly supplied to brake cylinders on the front right and left wheels or brake cylinders at front and rear orthogonal locations.

### CITATION LIST

### Patent Literature

[PTL 1] JP 2011-156998 A
[PTL 2] JP 2011-156999 A

### SUMMARY OF INVENTION

If the master cylinder in the brake device is a tandem type, for example, the hydraulic pressure (master cylinder pressure) is output from the master cylinder via a plurality of systems (specifically two systems). Then, in the brake device including the master cylinder of tandem type, in order to supply the pressure increasing mechanism with respective master cylinder pressures output from the master cylinder via the two systems, for example, a separation valve mechanism incorporating a separation piston as illustrated in FIG. 21 may have hitherto been installed in the pressure increasing mechanism. As a result, when a master cylinder pressure 1 and a master cylinder pressure 2 are supplied from the master cylinder via the two systems, the separation piston in the separation valve mechanism is operated in accordance with the supplied master cylinder pressures 1 and 2, to thereby be able to supply the pressure increasing mechanism with an appropriate master cylinder pressure.

By the way, the magnitudes of the master cylinder pressures 1 and 2 output from the master cylinder of the tandem type are the same in a normal state. Thus, as illustrated in FIG. 21, if a separation piston having the same pressure receiving areas is employed, forces acting on the separation piston are cancelled to each other in the normal state where the master cylinder pressures 1 and 2 having the same magnitude are supplied. As a result, the separation piston does not move (stroke) in response to the supply of the master cylinder pressures 1 and 2 in the normal state. Moreover, in the separation valve mechanism, as illustrated in FIG. 21, a seal member (such as an O ring) is provided on the separation piston in order to separate the master cylinder pressures 1 and 2 supplied via the two systems. Then, the master cylinder pressures 1 and 2 having the same magnitude act also on the seal member (such as an O ring) provided in this way in the normal state.

The separation piston in the separation valve mechanism does not stroke in the normal state as described above, and hence, for example, it cannot be determined whether the separation piston is stuck to the housing due to aged degradation or not. Moreover, the master cylinder pressures 1 and 2 having the same magnitude are acting on the seal member provided on the separation piston in the normal state, and hence, for example, it cannot be determined whether a seal function of the seal member is damaged due to aged degradation or not. Then, if those abnormalities occur, the servo pressure having an appropriate magnitude cannot be obtained by the pressure increasing mechanism, and the driver may feel a sense of discomfort during the brake operation.

If the related-art separation piston of the separation valve mechanism as illustrated in FIG. 21 is employed, in order to correctly determine the abnormalities occurring in the separation valve mechanism, it is necessary to increase or decrease one of the master cylinder pressures 1 and 2, thereby generating a pressure difference between the master cylinder pressures 1 and 2. However, if one of the master cylinder pressures 1 and 2 is increased or decreased, the brake operation by the driver may be influenced, resulting in possible degradation of the brake operation feeling sensed by the driver.

The present invention has been made in view of the above-mentioned problem, and has an object to provide a vehicle brake device for determining an abnormality occurring in a separation valve mechanism connected to a pressure increasing mechanism without degrading brake operation feeling.

In order to achieve the object, a vehicle brake device according to one embodiment of the present invention includes a wheel cylinder, a master cylinder, a power hydraulic pressure source, a linear control valve, hydraulic pressure detection means, and control means.

The wheel cylinder is configured to receive a hydraulic pressure of a working fluid and apply a braking force to a wheel. The master cylinder is configured to generate a hydraulic pressure in response to an operation by a driver on a brake pedal, and output the hydraulic pressure via a plurality of systems. The power hydraulic pressure source is configured to generate a hydraulic pressure through drive of a pressurizing pump. The linear control valve is configured to adjust the hydraulic pressure transmitted from the power hydraulic pressure source to the wheel cylinder. The hydraulic pressure detection means is configured to detect a hydraulic pressure output from at least one of the plurality of systems of the master cylinder. The control means is configured to control drive of the linear control valve based on the hydraulic pressure detected by the hydraulic pressure detection means.

One feature of the vehicle brake device according to one embodiment of the present invention resides in that: the master cylinder is configured to introduce therein a servo pressure generated in response to the brake pedal operation by the driver; and the servo pressure to be introduced into the master cylinder is supplied from a pressure increasing mechanism connected to a separation valve mechanism, the separation valve mechanism including a separation piston for separating and inputting hydraulic pressures output for each system from the master cylinder, the separation piston having pressure receiving areas different for each system, and being configured to mechanically move forward and backward depending on the input hydraulic pressure, the pressure increasing mechanism being configured to mechanically move by at least one of a hydraulic pressure output from the at least one of the plurality of systems of the master cylinder whose hydraulic pressure is detected by the hydraulic pressure detection means or a pressing force by the forward movement of the separation piston of the separation valve mechanism, to thereby generate a hydraulic pressure having a certain ratio with respect to the hydraulic pressure output from the master cylinder.

In this case, in the master cylinder, for example, a piston rod for coupling a pressurizing piston for pressurizing the stored working fluid and the brake pedal may be divided, and the piston rod may include a first piston rod connected to the brake pedal at one end, a second piston rod connected to the pressurizing piston at one end, and an elastic body for coupling the other end of the first piston rod and the other end of the second piston rod to each other, and adjusting the stroke caused by the operation by the driver on the brake pedal. The servo pressure may be introduced from the pressure increasing mechanism to at least the pressurizing piston and the other end of the first piston rod.

As a result, even in the normal state where the hydraulic pressures having the same magnitude are input from the respective systems of the master cylinder to the separation valve mechanism, the separation piston having the different pressure receiving areas can be moved forward and backward. Then, the pressure increasing mechanism can be operated by applying the pressing force by the forward movement out of the forward and backward movements of the separation piston, to thereby be able to generate a servo pressure. Therefore, for example, if an abnormality occurs in the forward/backward movement of the separation piston of the separation valve mechanism, the servo pressure generated by the pressure increasing mechanism changes, and hence an operation abnormality of the separation piston occurring in the separation valve mechanism can be easily determined based on the change in servo pressure, namely, a change in hydraulic pressure detected by the hydraulic pressure detection means.

Further, in this case, more specifically, the master cylinder may be configured to output the hydraulic pressure in response to the brake operation by the driver with use of two systems. Further, the separation piston of the separation valve mechanism may be configured so that a pressure receiving area for one of the two systems of the master cylinder is smaller than a pressure receiving area for another of the two systems of the master cylinder. Then, the pressure increasing mechanism may be configured to mechanically operate by at least one of a hydraulic pressure output from the one of the two systems of the master cylinder or the pressing force by the forward movement of the separation piston of the separation valve mechanism, to thereby generate the hydraulic pressure having the certain ratio with respect to the hydraulic pressure output from the master cylinder.

As a result, if the master cylinder outputs the hydraulic pressures via the two systems, the separation piston of the separation valve mechanism can be moved in a direction from the side having the larger pressure receiving area toward the side having the smaller pressure receiving area in the normal state. As a result, the pressure increasing mechanism can be operated by applying the pressing force by the forward movement of the separation piston in the normal state, to thereby be able to generate a servo pressure. On the other hand, for example, if an abnormality occurs in the forward/backward movement of the separation piston of the separation valve mechanism, the servo pressure generated by the pressure increasing mechanism apparently changes, and hence an operation abnormality of the separation piston occurring in the separation valve mechanism can be more easily determined based on the change in servo pressure, namely, the change in hydraulic pressure detected by the hydraulic pressure detection means.

Further, in those cases, the separation valve mechanism may further include: a housing for storing the separation piston; and a plurality of seal members provided between an outer peripheral surface of the separation piston and an inner peripheral surface of the housing, for separating the hydraulic pressures output for each system of the master cylinder from one another, and the separation valve mechanism may have a space into which the hydraulic pressure output from the master cylinder is prevented from entering by the plurality of seal members, the space communicating to a reservoir that is connected to the master cylinder and stores the working fluid, the space being partitioned by the outer peripheral surface of the separation piston, the inner peripheral surface of the housing, and the plurality of seal members, and being adjacent to spaces in which the hydraulic pressures output from the master cylinder for each system are input.

As a result, in a state where the seal function of the seal members is appropriately exerted, the spaces for inputting the hydraulic pressures output for each system from the master cylinder and the space communicating to the reservoir are partitioned from one another, and hence the hydraulic pressure detection means appropriately detects the hydraulic pressure from the master cylinder. However, in a state where the seal mechanism of the seal members is damaged, the spaces for inputting the hydraulic pressures output for each system from the master cylinder and the space communicating to the reservoir are not partitioned from one another, and hence the hydraulic pressure detection means detects the hydraulic pressure from the master cylinder as “0”. Thus, an abnormality of the seal function occurring in the separation valve mechanism can be more easily determined.

Further, another feature of the vehicle brake device according to one embodiment of the present invention resides in that the separation valve mechanism further includes an elastic body for adjusting a stroke of the separation piston configured to mechanically move forward and backward depending on the hydraulic pressures output for each system from the master cylinder. In this case, the elastic body can adjust the stroke when the separation piston moves backward in a direction separating from the pressure increasing mechanism.

As a result, for example, when the separation piston in the separation valve mechanism moves forward and backward in the state where the hydraulic pressures output via the respective systems from the master cylinder cannot be input in a separated manner, the elastic body can appropriately adjust the stroke of the separation piston. As a result, the volume of the space formed by the separation piston in the separation valve mechanism and used for storing the working fluid supplied from the master cylinder can be appropriately changed, and the brake operation feeling sensed by the driver when the brake pedal connected to the master cylinder is operated can be maintained in an excellent state.

Further, another feature of the vehicle brake device according to one embodiment of the present invention resides in that the vehicle brake device further includes stroke detection means for detecting a magnitude of a stroke input to the master cylinder in response to the operation by the driver on the brake pedal, and the control means determines whether or not an abnormality occurs in the separation valve mechanism based on a magnitude of the hydraulic pressure output from the master cylinder and detected by the hydraulic pressure detection means and the magnitude of the stroke detected by the stroke detection means. In this case, the control means may include determination means for determining whether or not an abnormality occurs in the separation valve mechanism based on the magnitude of the hydraulic pressure output from the master cylinder and detected by the hydraulic pressure detection means and the magnitude of the stroke detected by the stroke detection means.

Then, in this case, more specifically, the control means may determine that, based on a relationship between the hydraulic pressure output from the master cylinder and the stroke input to the master cylinder, which is satisfied in a normal state where no abnormality occurs in the separation valve mechanism, when a difference value between the magnitude of the hydraulic pressure output from the master cylinder in the normal state and the magnitude of the hydraulic pressure output from the master cylinder and detected by the hydraulic pressure detection means with respect to the magnitude of the stroke detected by the stroke detection means is larger than a predetermined value, such an abnormality occurs that the separation piston of the separation valve mechanism is stuck to the housing forming the separation valve mechanism and storing the separation piston, and the pressure increasing mechanism is mechanically operated only by the hydraulic pressure supplied from the master cylinder.

Further, in those cases, the control means may determine that, in a state where an ineffective stroke which does not increase the magnitude of the hydraulic pressure output from the master cylinder and detected by the hydraulic pressure detection means with respect to an increase in the magnitude of the stroke detected by the stroke detection means is increasing, when the magnitude of the hydraulic pressure output from the master cylinder and detected by the hydraulic pressure detection means does not tend to increase, such an abnormality occurs that a seal function of the seal member provided between the housing, which forms the separation valve mechanism and stores the separation piston, and the separation piston, for separating the hydraulic pressures output for each system of the master cylinder from each other, is damaged, and the pressure increasing mechanism is mechanically operated only by the pressing force by the forward movement of the separation piston of the separation valve mechanism.

In addition, in those cases, the control means may determine that, in a state where an ineffective stroke which does not increase the magnitude of the hydraulic pressure output from the master cylinder and detected by the hydraulic pressure detection means with respect to an increase in the magnitude of the stroke detected by the stroke detection means is increasing, when the magnitude of the hydraulic pressure output from the master cylinder and detected by the hydraulic pressure detection means tends to increase, such an abnormality occurs that a seal function of the seal member provided between the housing, which forms the separation valve mechanism and stores the separation piston, and the separation piston, for separating the hydraulic pressures output for each system of the master cylinder, is damaged, and the pressure increasing mechanism is mechanically operated only by the hydraulic pressure supplied from the master cylinder.

As a result, a content of the abnormality occurring in the separation valve mechanism, namely, such abnormalities that the separation piston is stuck to the housing and that the seal function of the seal member is damaged can be determined only by using the magnitude of the hydraulic pressure output from the master cylinder and detected by the hydraulic pressure detection means and the magnitude of the stroke detected by the stroke detection means. Thus, an abnormality in the separation valve mechanism can be extremely easily determined.

Further, another feature of the vehicle brake device according to one embodiment of the present invention resides in that when the control means determines that an abnormality occurs in the separation valve mechanism, the control means is configured to: correct the magnitude of the hydraulic pressure output from the master cylinder and detected by the hydraulic pressure detection means by increasing the magnitude, based on a relationship between the hydraulic pressure output from the master cylinder and the stroke input to the master cylinder, which is satisfied in a normal state where no abnormality occurs in the separation valve mechanism, until the magnitude matches the magnitude output from the master cylinder in the normal state; and use the increased and corrected magnitude of the hydraulic pressure output from the master cylinder to continue the drive control for the linear control valve.

As a result, when an abnormality occurs in the separation valve mechanism, and a servo pressure having an appropriate magnitude is not introduced from the pressure increasing mechanism to the master cylinder, the control means corrects the magnitude of the hydraulic pressure output from the master cylinder and detected by the hydraulic pressure detection means by increasing the magnitude until the magnitude matches the magnitude of the hydraulic pressure output from the master cylinder in the normal state based on the relationship between the hydraulic pressure output from the master cylinder and the stroke which is satisfied in the normal state.

As a result, the control means can use the corrected magnitude of the hydraulic pressure output from the master cylinder to continue the drive control for the linear control valve. Thus, even if an abnormality occurs in the separation valve mechanism, the driver does not feel a sense of discomfort, but can continue to enjoy appropriate brake operation feeling. Note that, even if the driver can continue to enjoy the appropriate brake operation feeling without feeling a sense of discomfort, the abnormality occurs in the separation valve mechanism, and hence it is preferred that the control means notify the driver of the abnormality occurring in the separation valve mechanism by using, for example, an indicator or the like.

### BRIEF DESCRIPTION OF DRAWINGS

FIG. 1 is a schematic system diagram of a vehicle brake device according to an embodiment of the present invention.

FIG. 2 is a schematic cross-sectional view illustrating a configuration of a pressure increasing mechanism and a separation valve mechanism of FIG. 1.

FIG. 3 is a diagram illustrating operations of the pressure increasing mechanism and the separation valve mechanism of FIG. 2.

FIG. 4 is a diagram illustrating a linear control mode state by the vehicle brake device according to the embodiment of the present invention.

FIG. 5 is a diagram illustrating an operation of the pressure increasing mechanism when a separation piston (stepped piston) of the separation valve mechanism is stuck.

FIG. 6 is a graph showing a relationship between a stroke and a hydraulic pressure (master cylinder pressure) of a master cylinder when the separation piston (stepped piston) of the separation valve mechanism is stuck.

FIG. 7 is a diagram illustrating operations of the master cylinder and the pressure increasing mechanism when a seal function of a small diameter chamber is damaged in the separation piston (stepped piston) of the separation valve mechanism.

FIG. 8 is a graph showing a relationship between the stroke and the hydraulic pressure (master cylinder pressure) of the master cylinder when the seal function of the small diameter chamber is damaged in the separation piston (stepped piston) of the separation valve mechanism.

FIG. 9 is a diagram illustrating operations of the master cylinder and the pressure increasing mechanism when a seal function of a large diameter chamber is damaged in the separation piston (stepped piston) of the separation valve mechanism.

FIG. 10 is a graph showing a relationship between the stroke and the hydraulic pressure (master cylinder pressure) of the master cylinder when the seal function of the large diameter chamber is damaged in the separation piston (stepped piston) of the separation valve mechanism.

FIG. 11 is a diagram illustrating a balance among forces when a servo pressure is present and absent in a general master cylinder.

FIG. 12 is a graph showing a relationship between the stroke and the hydraulic pressure (master cylinder pressure) when the servo pressure is present and absent in the general master cylinder.

FIG. 13 is a diagram illustrating a balance among forces when the servo pressure is present and absent in the master cylinder of FIG. 1.

FIG. 14 is a graph showing a relationship between the stroke and the hydraulic pressure (master cylinder pressure) when the servo pressure is present and absent in the master cylinder of FIG. 1.

FIG. 15 is a flowchart illustrating an abnormality determination program.

FIG. 16 is a flowchart illustrating a linear control continuation program.

FIG. 17 is a graph showing a correction of the hydraulic pressure (master cylinder pressure) when an abnormality occurs in the separation valve mechanism.

FIG. 18 is a schematic cross-sectional view illustrating a configuration of a pressure increasing mechanism and a separation valve mechanism according to a modified example of the present invention.

FIG. 19 is a diagram illustrating operations of the master cylinder and the pressure increasing mechanism when the seal function of the large diameter chamber is damaged in the separation piston (stepped piston) of the separation valve mechanism according to the modified example of the present invention.

FIG. 20 is a graph showing a relationship between the stroke and the hydraulic pressure (master cylinder pressure) of the master cylinder when the seal function of the large diameter chamber is damaged in the separation piston (stepped piston) of the separation valve mechanism according to the modified example of the present invention.

FIG. 21 is a diagram illustrating a balance among forces in a separation piston of a related-art separation valve mechanism.

### DESCRIPTION OF EMBODIMENTS

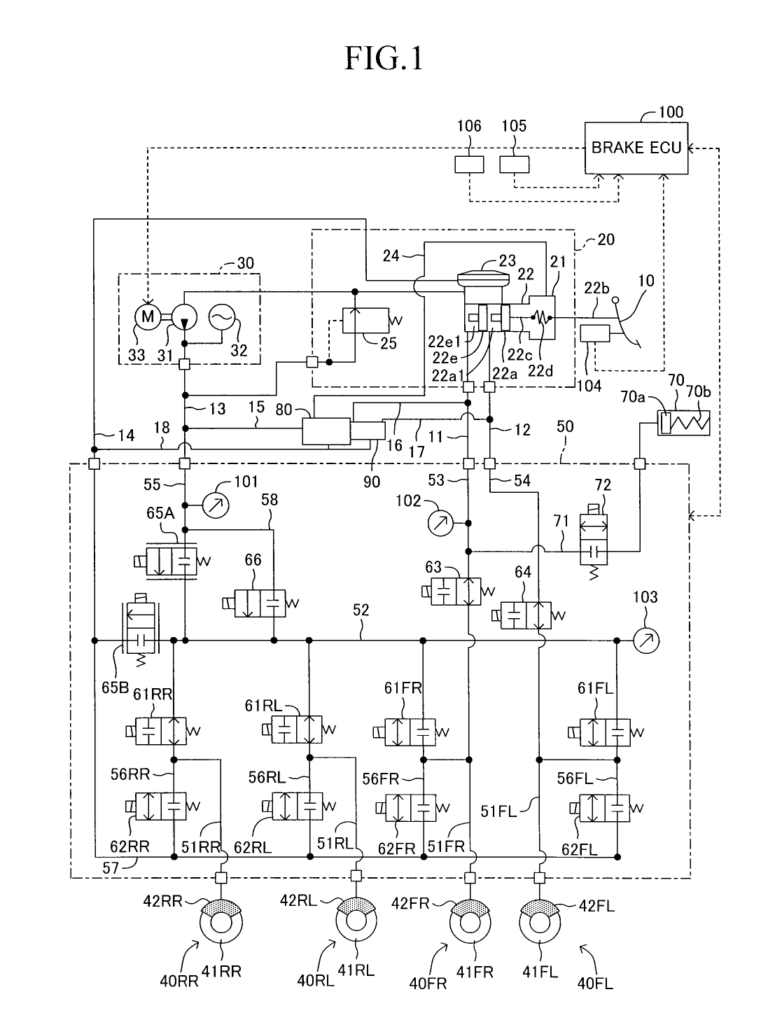

Now, a vehicle brake device according to an embodiment of the present invention is described referring to the drawings. FIG. 1 is a schematic system diagram of the vehicle brake device according to this embodiment.

The brake device according to this embodiment includes a brake pedal 10, a master cylinder unit 20, a power hydraulic pressure generation device 30, a hydraulic pressure control valve device 50, a pressure increasing mechanism 80, a separation valve mechanism 90, and a brake ECU 100 for brake control. Brake units 40FR, 40FL, 40RR, and 40RL installed on respective wheels include brake rotors 41FR, 41FL, 41RR, and 41RL, and wheel cylinders 42FR, 42FL, 42RR, and 42RL integrated into brake calipers. The brake units 40 are not limited to the case where disk brakes are installed on all the four wheels, and, for example, drum brakes may be installed on all the four wheels, or the disk brakes and the drum brakes may be arbitrarily combined in such a way that the disk brakes are installed on the front wheels and the drum brakes are installed on the rear wheels. In the following description, configurations provided for the respective wheels are denoted by suffixes FR for the front right wheel, FL for the front left wheel, RR for the rear right wheel, and RL for the rear left wheel, but if the specification of the wheel position is not particularly necessary, the suffix is omitted.

The wheel cylinders 42FR, 42FL, 42RR, and 42RL are connected to the hydraulic pressure control valve device 50, and receive transmitted hydraulic pressures of the working fluid (brake fluid) supplied from the hydraulic pressure control device 50. Then, brake pads are pressed against the brake rotors 41FR, 41FL, 41RR, and 41RL rotating along with the wheels by the hydraulic pressure supplied from the hydraulic pressure control valve device 50, thereby applying braking forces to the wheels.

The master cylinder unit 20 includes a hydraulic pressure booster 21, a master cylinder 22, a reservoir 23, and a servo pressure pipe 24. The hydraulic pressure booster 21 is coupled to the brake pedal 10, and amplifies a pedal stepping force F (hereinafter simply referred to as “stepping force F”) applied by the driver to the brake pedal 10. In other words, the hydraulic pressure booster 21 amplifies the stepping force F by being supplied with the working fluid (more specifically, a servo pressure Ps) via the servo pressure pipe 24 from the pressure increasing mechanism 80 for increasing the pressure of the working fluid by a mechanical operation as described later and the separation valve mechanism 90 as described later.

The master cylinder 22 includes a pressurizing piston 22a, a first piston rod 22b coupled to the brake pedal 10, and a second piston rod 22c coupled to the pressurizing piston 22a. Then, the master cylinder 22 includes a stroke adjustment spring 22d arranged between the first piston rod 22b and the second piston rod 22c to couple the rods 22b and 22c to each other, for serving as an elastic body for adjusting a stroke caused by the stepping operation on the brake pedal 10. Moreover, the master cylinder 22 is a tandem type including a pressurizing piston 22e as well as the pressurizing piston 22a, and the pressurizing pistons 22a and 22e are configured to stroke in response to the stepping force F input by the stepping operation on the brake pedal 10 via the first piston rod 22b, the stroke adjustment spring 22d, and the second piston rod 22c, thereby each generating a master cylinder pressure Pmc having a predetermined boost ratio.

The reservoir 23 for storing the working fluid is provided at a top of the master cylinder 22. In the master cylinder 22, when the stepping operation on the brake pedal 10 is released, and the pressurizing pistons 22a and 22e are retracted, pressurizing chambers 22a1 and 22e1 formed by the pressurizing pistons 22a and 22e communicate to the reservoir 23.

The power hydraulic pressure generation device 30 is a power hydraulic pressure source, and includes a pressurizing pump 31 and an accumulator 32. The pressurizing pump 31 has an inlet opening connected to the reservoir 23 and an outlet opening connected to the accumulator 32, and drives the motor 33 to pressurize the working fluid. The accumulator 32 converts pressure energy of the working fluid pressurized by the pressurizing pump 31 into pressure energy of a filler gas such as nitrogen, thereby accumulating the pressure energy. Moreover, the accumulator 32 is connected to a relief valve 25 provided to the master cylinder unit 20. The relief valve 25 opens when the pressure of the working fluid increases to a predetermined pressure or more, thereby returning the working fluid to the reservoir 23.

In this way, the brake device includes, as the hydraulic pressure source for applying a hydraulic pressure of the working fluid to the wheel cylinders 42, the master cylinder 22 for applying the hydraulic pressure by using the stepping force F input by the driver via the brake pedal 10, and the power hydraulic pressure generation device 30 for applying the hydraulic pressure independently of the master cylinder 22. Then, in the brake device, the master cylinder 22 and the power hydraulic pressure generation device 30 are connected respectively via master pressure pipes 11 and 12 and an accumulator pressure pipe 13 to the hydraulic pressure control valve device 50. Moreover, the reservoir 23 is connected via a reservoir pipe 14 to the hydraulic pressure control valve device 50.

The hydraulic pressure control valve device 50 includes four individual flow passages 51FR, 51FL, 51RR, and 51RL connected to the respective wheel cylinders 42FR, 42FL, 42RR, and 42RL, a main flow passage 52 for communicating to the individual flow passages 51FR, 51FL, 51RR, and 51RL, master pressure flow passages 53 and 54 for connecting the individual flow passages 51FR and 51FL and the master pressure pipes 11 and 12, respectively, to each other, and an accumulator pressure flow passage 55 for connecting the main flow passage 52 and the accumulator pressure pipe 13 to each other. The master pressure flow passages 53 and 54 and the accumulator pressure flow passage 55 are connected in parallel with one another to the main flow passage 52.

Holding valves 61FR, 61FL, 61RR, and 61RL are respectively provided on the individual flow passages 51FR, 51FL, 51RR, and 51RL. According to this embodiment, the holding valves 61FR and 61FL respectively provided on the brake unit 40FR for the front right wheel and on the brake unit 40FL for the front left wheel are electromagnetic normally-closed on-off valves which are each configured to maintain a closed state by a biasing force of a spring in a non-current supply state of a solenoid, and be brought into an open state only in a current supply state of the solenoid. The holding valves 61RR and 61RL respectively provided on the brake unit 40RR for the rear right wheel and on the brake unit 40RL for the rear left wheel are electromagnetic normally-open on-off valves which are each configured to maintain an open state by a biasing force of a spring in a non-current supply state of a solenoid, and be brought into a closed state only in a current supply state of the solenoid.

As a result, in the holding valves 61FR and 61FL respectively provided on the right and left brake units 40FR and 40FL on the front wheel side, and the holding valves 61RR and 61RL respectively provided on the right and left brake units 40RR and 40RL on the rear wheel side, the holding valves on the front wheel side are the normally-closed electromagnetic on-off valves, and the holding valves on the rear wheel side are the normally-open electromagnetic on-off valves. As a result, when the holding valves 61FR and 61FL, which are the normally-closed electromagnetic on-off valves, are in the open state by the current supply to the solenoids on the right and left brake units 40FR and 40FL on the front wheel side, the main flow passage 52 and the wheel cylinders 42FR and 42FL communicate to each other. Moreover, when the holding valves 61RR and 61RL, which are the normally-open electromagnetic on-off valves, are in the closed state by the current supply to the solenoids on the right and left brake units 40RR and 40RL on the rear wheel side, the communication of the main flow passage 52 and the wheel cylinders 42RR and 42RL is shut off.

Moreover, pressure decreasing individual flow passages 56FR, 56FL, 56RR, and 56RL are respectively connected to the individual flow passages 51FR, 51FL, 51RR, and 51RL. The respective pressure decreasing individual flow passages 56 are connected to a reservoir flow passage 57. The reservoir flow passage 57 is connected via the reservoir pipe 14 to the reservoir 23. Pressure decreasing valves 62FR, 62FL, 62RR, and 62RL are respectively provided at intermediate portions of the pressure decreasing individual flow passages 56FR, 56FL, 56RR, and 56RL. The respective pressure decreasing valves 62 are normally-closed electromagnetic on-off valves which are each configured to maintain a closed state by a biasing force of a spring in a non-current supply state of a solenoid, and be brought into an open state only in a current supply state of the solenoid. In the open state, each pressure decreasing valve 62 causes the working fluid to flow from the wheel cylinder 42 via the pressure decreasing individual flow passage 56 to the reservoir flow passage 57, thereby decreasing a wheel cylinder pressure (corresponding to a control pressure Px described later).

Master cut valves 63 and 64 are respectively provided at intermediate portions of the master pressure flow passages 53 and 54. The respective master cut valves 63 and 64 are normally-open electromagnetic on-off valves which are each configured to maintain an open state by a biasing force of a spring in a non-current supply state of a solenoid, and be brought into a closed state only in a current supply state of the solenoid. By providing the master cut valves 63 and 64 as described above, when the master cut valves 63 and 64 are in the closed state, the communication of the working fluid is shut off between the master cylinder 22 and the individual flow passages 51FL and 51FR, and when the master cut valves 63 and 64 are in the open state, the communication of the working fluid is permitted between the master cylinder 22 and the individual flow passages 51FL and 51FR.

Moreover, according to this embodiment, a simulator flow passage 71 is provided to the master pressure flow passage 53 so as to branch on an upstream side (master cylinder 22 side) with respect to the master cut valve 63. In this case, it should be understood that the present invention can also be carried out so that the simulator flow passage 71 is provided to the master pressure flow passage 54 on an upstream side with respect to the master cut valve 64. A stroke simulator 70 is connected via a simulator cut valve 72 to the simulator flow passage 71. The simulator cut valve 72 is a normally-closed electromagnetic on-off valve which is configured to maintain a closed state by a biasing force of a spring in a non-current supply state of a solenoid, and be brought into an open state only in a current supply state of the solenoid. As a result, when the simulator cut valve 72 is in the closed state, the communication of the working fluid is shut off between the master pressure flow passage 53 (or the master pressure flow passage 54) and the stroke simulator 70, and when the simulator cut valve 72 is in the open state, the communication of the working fluid is permitted between the master pressure flow passage 53 (or the master pressure flow passage 54) and the stroke simulator 70.

The stroke simulator 70 includes a piston 70a and a spring 70b, and introduces the working fluid in an amount corresponding to a brake operation amount (corresponding to a stroke Sm described later) on the brake pedal 10 by the driver into the inside thereof when the simulator cut valve 72 is in the open state. Then, the stroke simulator 70 displaces the piston 70a against the biasing force of the spring 70b in synchronous with the introduction of the working fluid (namely, the master cylinder pressure Pmc described later, more specifically, a master cylinder pressure Pmc1) into the inside, thereby enabling a stroke operation of the brake pedal 10 by the driver, and generating a reaction force corresponding to the brake operation amount to provide appropriate brake operation feeling to the driver.

A pressure increasing linear control valve 65A is provided at an intermediate portion of the accumulator pressure flow passage 55. Moreover, a pressure decreasing linear control valve 65B is provided between a connected point of the accumulator pressure flow passage 55 to the main flow passage 52 and the reservoir flow passage 57. The pressure increasing linear control valve 65A and the pressure decreasing linear control valve 65B are normally-closed electromagnetic linear control valves which are each configured to maintain a closed state by a biasing force of a spring in a non-current supply state of a solenoid, and increase a valve opening degree along with an increase in current supply amount (current value) to the solenoid. A detailed description is not given of the pressure increasing linear control valve 65A and the pressure decreasing linear control valve 65B, but each of the pressure increasing linear control valve 65A and the pressure decreasing linear control valve 65B maintains the closed state by a valve closing force represented by a difference between a spring force of biasing a valve body toward a valve closing direction by the built-in spring and a pressure difference force of biasing the valve body toward a valve opening direction by a pressure difference between a primary side (inlet side) through which the working fluid relatively high in pressure communicates and a secondary side (outlet side) through which the working fluid relatively low in pressure communicates.

On the other hand, each of the pressure increasing linear control valve 65A and the pressure decreasing linear control valve 65B opens at an opening degree corresponding to a balance between the forces acting on the valve body if an electromagnetic attraction force generated by the current supply to the solenoid and acting toward the direction to open the valve body exceeds the valve closing force, in other words, if a relationship of “electromagnetic attraction force>valve closing force (=spring force-pressure difference force)” holds true. Thus, by controlling the current supply amount (current value) to the solenoid, each of the pressure increasing linear control valve 65A and the pressure decreasing linear control valve 65B can adjust the opening degree corresponding to the pressure difference force, namely, the pressure difference between the primary side (inlet side) and the secondary side (outlet side). On this occasion, the pressure increasing linear control valve 65A and the pressure decreasing linear control valve 65B correspond to linear control valves according to the present invention. In the following description, if the pressure increasing linear control valve 65A and the pressure decreasing linear control valve 65B do not need to be distinguished from each other, they are also simply referred to as linear control valve 65.

Moreover, a branch flow passage 58 is provided to the accumulator pressure flow passage 55 at a location closer to the accumulator 32 than the pressure increasing linear control valve 65A in order to secure a volume (flow rate) of the working fluid supplied to the respective wheel cylinders 42. The branch flow passage 58 is connected via an adjusted flow rate cut valve 66 to the main flow passage 52. The adjusted flow rate cut valve 66 is a normally-closed electromagnetic on-off valve which is configured to maintain a closed state by a biasing force of a spring in a non-current supply state of a solenoid, and be brought into an open state only in a current supply state of the solenoid. As a result, when the adjusted flow rate cut valve 66 is in the closed state, the communication of the working fluid via the branch flow passage 58 is shut off, and the working fluid (namely, an adjusted accumulator pressure Pacc described later) is supplied only via the pressure increasing linear control valve 65A from the accumulator 32 to the main flow passage 52. Moreover, when the adjusted flow rate cut valve 66 is in the open state, the working fluid (namely, the accumulator pressure Pacc) is supplied via the branch flow passage 58 from the accumulator 32 to the main flow passage 52 in addition to the working fluid (namely, the adjusted accumulator pressure Pacc) supplied via the pressure increasing linear control valve 65A from the accumulator 32 to the main flow passage 52.

Moreover, the pressure increasing mechanism 80 for supplying the hydraulic pressure booster 21 of the master cylinder unit 20 with the servo pressure Ps is provided in the brake device in order to reduce a load during the stepping operation by the driver on the brake pedal 10. A description is now given of the pressure increasing mechanism 80 according to this embodiment. Note that, as the pressure increasing mechanism 80, any structure capable of always supplying the hydraulic pressure booster 21 with the servo pressure Ps by a mechanical operation as described later can be employed.

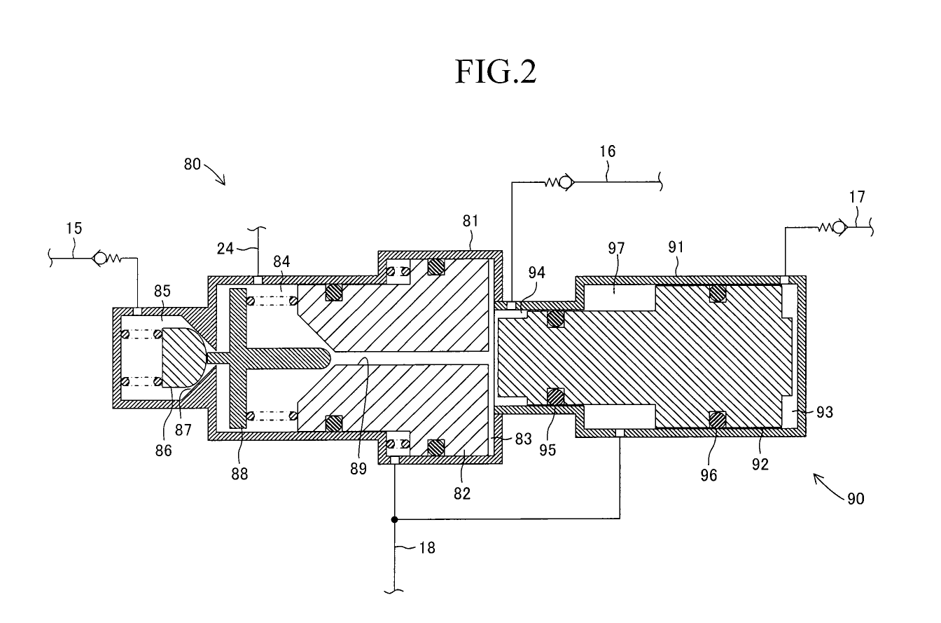

As illustrated in FIG. 2, the pressure increasing mechanism 80 includes a housing 81, and a stepped piston 82 fitted into the housing 81 in a liquid-tight and slidable manner. A large diameter chamber 83 is provided on a large diameter side of the stepped piston 82, and a small diameter chamber 84 is provided on a smaller diameter side thereof. The small diameter chamber 84 can communicate to a high pressure chamber 85 connected to the accumulator 32 of the power hydraulic pressure generation device 30 via a high pressure supply valve 86 and a valve seat 87. As illustrated in FIG. 2, the high pressure supply valve 86 is pressed against the valve seat 87 by a biasing force of a spring in the high pressure chamber 85, and is a normally-closed valve.

Moreover, a valve opening member 88 is provided in the small diameter chamber 84 so as to oppose the high pressure supply valve 86, and a spring is provided between the valve opening member 88 and the stepped piston 82. A biasing force of the spring acts toward a direction of separating the valve opening member 88 from the stepped piston 82. Moreover, as illustrated in FIG. 2, a return spring is provided between a step portion of the stepped piston 82 and the housing 81, thereby biasing the stepped piston 82 toward a backward moving direction. Note that, a stopper (not shown) is provided between the stepped piston 82 and the housing 81, thereby regulating a forward movement end position of the stepped piston 82.

Further, a communication passage 89 for communicating the large diameter chamber 83 and the small diameter chamber 84 to each other is formed in the stepped piston 82. The communication passage 89 causes the large diameter chamber 83 and the small diameter chamber 84 to communicate to each other in a state where the stepped piston 82 is separated from the valve opening member 88 at at least a backward movement end position of the stepped piston 82, and, when the stepped piston 82 moves forward to abut against the valve opening member 88, the communication passage 89 is shut off. The pressure increasing mechanism 80 configured in this way operates as a mechanical pressure increasing device (mechanical servo).

Note that, as illustrated in FIGS. 1 and 2, the high pressure chamber 85 and the power hydraulic pressure generation device 30 are connected to each other via the high pressure supply passage 15, and a check valve for permitting communication of the working fluid from the power hydraulic pressure generation device 30 (more specifically, from the accumulator 32) to the high pressure chamber 85 and preventing communication in an opposite direction is provided on the high pressure supply flow passage 15. The check valve provided in this way permits the communication of the working fluid from the power hydraulic pressure generation device 30 to the high pressure chamber 85 when the hydraulic pressure (namely, the accumulator pressure Pacc) of the power hydraulic pressure generation device 30 (more specifically, the accumulator 32) is higher than the hydraulic pressure of the high pressure chamber 85. The check valve is in the closed state when the hydraulic pressure (namely, the accumulator pressure Pacc) of the power hydraulic pressure generation device 30 is equal to or lower than the hydraulic pressure of the high pressure chamber 85, and prevents the flows in the both directions. Thus, even if a liquid leak occurs in the power hydraulic pressure generation device 30, the working fluid is prevented from flowing backward from the high pressure chamber 85 to the power hydraulic pressure generation device 30, and the hydraulic pressure in the small diameter chamber 84 is prevented from decreasing.

The separation valve mechanism 90 for separating and outputting the master cylinder pressures Pmc output from the master cylinder 22 into two systems is connected to the pressure increasing mechanism 80 configured in this way. Specifically, the separation valve mechanism 90 appropriately separates and inputs the two systems including the master cylinder pressure Pmc supplied from the master pressure pipe 11 (the master cylinder pressure Pmc supplied from the master pressure pipe 11 is hereinafter referred to as “master cylinder pressure Pmc1”) and the master cylinder pressure Pmc supplied from the master pressure pipe 12 (the master cylinder pressure Pmc supplied from the master pressure pipe 12 is hereinafter referred to as “master cylinder pressure Pmc2”). The separation valve mechanism 90 outputs the master cylinder pressures Pmc to the pressure increasing mechanism 80.

Therefore, as illustrated in FIG. 2, the separation valve mechanism 90 includes a housing 91, and a stepped piston 92 fitted into the housing 91 in a liquid-tight and slidable manner and serving as a separation piston. A large diameter chamber 93 is provided on a large diameter side of the stepped piston 92, and a small diameter chamber 94 is provided on a small diameter side thereof. The stepped piston 92 is configured to come into contact with and to press the end surface on the large diameter side of the stepped piston 82 of the pressure increasing mechanism 80 at a forward movement end position. The small diameter chamber 94 communicates to the large diameter chamber 83 of the pressure increasing mechanism 80, and receives the supply of the master cylinder pressure Pmc1 via the first master pressure supply passage 16 connected to the master pressure pipe 11. The large diameter chamber 93 receives the supply of the master cylinder pressure Pmc2 via the second master pressure supply passage 17 connected to the master pressure pipe 12. A check valve is provided on the first master pressure supply passage 16, for permitting communication of the working fluid from the master pressure pipe 11 (namely, the master cylinder 22) to the small diameter chamber 94 (namely, the large diameter chamber 83 of the pressure increasing mechanism 80) of the separation valve mechanism 90, and preventing communication in an opposite direction. Moreover, a check valve is provided on the second master pressure supply passage 17, for permitting communication of the working fluid from the master pressure pipe 12 (namely, the master cylinder 22) to the large diameter chamber 93 of the separation valve mechanism 90, and preventing communication in an opposite direction.

Moreover, a seal member 95 (specifically, an O ring) is provided on the small diameter side of the stepped piston 92, for securing a seal function in a gap between the seal member 95 and an inner peripheral surface of the housing 91 so as to secure liquid tightness of the small diameter chamber 94 and partition the small diameter chamber 94. A seal member 96 (specifically, an O ring) is provided on the large diameter side of the stepped piston 92, for securing a seal function in a gap between the seal member 96 and the inner peripheral surface of the housing 91 so as to secure liquid tightness of the large diameter chamber 93 and partition the large diameter chamber 93. As a result, the master cylinder pressure Pmc1 supplied via the first master pressure supply passage 16 connected to the master pressure pipe 11 to the small diameter chamber 94 and the master cylinder pressure Pmc2 supplied via the second master pressure supply passage 17 connected to the master pressure pipe 12 to the large diameter chamber 93 are separated from each other. Then, a gap between a step portion of the stepped piston 92 and the housing 91, namely, a reservoir chamber 97 is connected via a reservoir passage 18 to the reservoir 23. The reservoir chamber 97 is a space adjacent to the small diameter chamber 94 to which the master cylinder pressure Pmc1 is input and the large diameter chamber 93 to which the master cylinder pressure Pmc2 is input, and is partitioned by the seal members 95 and 96. The master cylinder pressures Pmc1 and Pmc2 and not input to the reservoir chamber 97. Note that, the reservoir passage 18 connects also a space formed between a step portion of the stepped piston 82 of the pressure increasing mechanism 80 and the housing 81 to the reservoir 23.

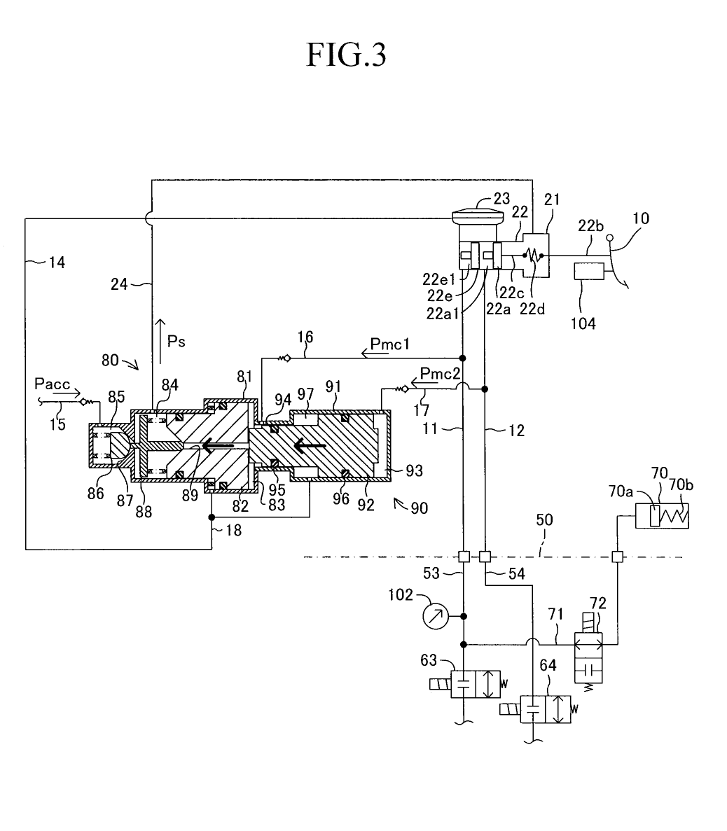

Specifically, referring to FIG. 3, a description is now given of operations of the pressure increasing mechanism 80 and the separation valve mechanism 90. In the separation valve mechanism 90, when the master cylinder pressure Pmc2 is supplied to the large diameter chamber 93, and the master cylinder pressure Pmc1 is supplied to the small diameter chamber 94, if the master cylinder pressure Pmc2 and the master cylinder pressure Pmc1 have the same magnitude, the stepped piston 92 moves forward toward the pressure increasing mechanism 80 depending on a difference between a pressure receiving area on the large diameter side and a pressure receiving area on the small diameter side of the stepped piston 92, more specifically, a difference between a force acting on the large diameter side of the stepped piston 92 represented as (pressure receiving area on large diameter side×master cylinder pressure Pmc2) and a force acting on the small diameter side of the piston 92 represented as (pressure receiving area on small diameter side×master cylinder pressure Pmc1). Then, when the stepped piston 92 abuts against the end surface of the pressure increasing mechanism 80 on the large diameter side, the stepped piston 92 presses the stepped piston 82 of the pressure increasing mechanism 80 by a forward movement force, which is acquired by subtracting (pressure receiving area on small diameter side×master cylinder pressure Pmc1) from (pressure receiving area on large diameter side×master cylinder pressure Pmc2), namely, a pressing force.

On the other hand, as illustrated in FIG. 3, in the pressure increasing mechanism 80, when the master cylinder pressure Pmc1 is supplied to the large diameter chamber 83 communicating to the small diameter chamber 94 of the separation valve mechanism 90, the master cylinder pressure Pmc1 is also supplied via the communication passage 89 to the small diameter chamber 84. Then, when the force in the forward moving direction acting on the stepped piston 82 by the supply of the master cylinder pressure Pmc1 and the pressing force of the stepped piston 92 of the separation valve mechanism 90 becomes larger than the biasing force of the return spring, the stepped piston 82 moves forward. Then, when the stepped piston 82 abuts against the valve opening member 88, and the communication passage 89 is shut off, the hydraulic pressure in the small diameter chamber 84 increases, and the working fluid increased in pressure (namely, the servo pressure Ps) is output via the servo pressure pipe 24 to the hydraulic pressure booster 21.

Moreover, when the high pressure supply valve 86 is switched to the open state by the forward movement of the valve opening member 88, the high pressure working fluid is supplied from the high pressure chamber 85 to the small diameter chamber 84, resulting in an increase in hydraulic pressure of the small diameter chamber 84. On the other hand, if the hydraulic pressure of the working fluid accumulated in the accumulator 32 of the power hydraulic pressure generation device 30 is higher than the hydraulic pressure in the high pressure chamber 85, the hydraulic pressure in the accumulator 32 is supplied via the check valve on the high pressure supply passage 15 to the high pressure chamber 85, and is then supplied to the small diameter chamber 84. Then, in the stepped piston 82, the hydraulic pressure in the large diameter chamber 83, namely, the master cylinder pressure Pmc1 is adjusted to such a magnitude that the force acting on the large diameter side (master cylinder pressure Pmc1×pressure receiving area and the pressing force of the stepped piston 92 of the separation valve mechanism 90) and the force acting on the small diameter side (servo pressure×pressure receiving area) are balanced each other, and the adjusted master cylinder pressure Pmc1 is output. Thus, the pressure increasing mechanism 80 can be considered as a mechanical booster mechanism.

On the other hand, when the hydraulic pressure in the accumulator 32 is equal to or less than the hydraulic pressure in the high pressure chamber 85, the check valve provided on the high pressure supply passage 15 prevents the flow of the working fluid between the accumulator 32 and the high pressure chamber 85, and the stepped piston 82 cannot move forward any more. Moreover, the stepped piston 82 may abut against the stopper to be restrained from moving forward.

The power hydraulic pressure generation device 30 and the hydraulic pressure control valve device 50 are controlled to be driven by the brake ECU 100 serving as control means. The brake ECU 100 includes a microcomputer constructed by a CPU, a ROM, a RAM, and the like as a main component, and includes a pump drive circuit, an electromagnetic valve drive circuit, an interface for inputting various sensor signals, and a communication interface. All the respective electromagnetic on-off valves 61 to 64, 66, and 72, and the linear control valves 65 provided in the hydraulic pressure control valve device 50 are connected to the brake ECU 100, and the open/closed states and the opening degrees (for the linear control valves 65) are controlled by solenoid drive signals output from the brake ECU 100. Moreover, the motor 33 provided to the power hydraulic pressure generation device 30 is also connected to the brake ECU 100, and is controlled to be driven by a motor drive signal output from the brake ECU 100.

The hydraulic pressure control valve device 50 is provided with an accumulator pressure sensor 101, a master cylinder pressure sensor 102, and a control pressure sensor 103 as hydraulic pressure detection means. The accumulator pressure sensor 101 detects the accumulator pressure Pacc which is a hydraulic pressure of the working fluid in the accumulator pressure flow passage 55 on the power hydraulic pressure generation device 30 side (upstream side) with respect to the pressure increasing linear control valve 65A. The accumulator pressure sensor 101 outputs a signal representing the detected accumulator pressure Pacc to the brake ECU 100. The brake ECU 100 reads the accumulator pressure Pacc at a predetermined cycle, and, if the accumulator pressure Pacc is less than the predetermined lowest set pressure, the brake ECU 100 drives the motor 33 to pressurize the working fluid by the pressurizing pump 31, thereby controlling the accumulator pressure Pacc to be always maintained within a set pressure range.

The master cylinder pressure sensor 102 according to this embodiment, which is hydraulic pressure detection means, detects the master cylinder pressure Pmc which is a hydraulic pressure of the working fluid in the master pressure flow passage 53 on the master cylinder 22 side (upstream side) with respect to the master cut valve 63. More specifically, the master pressure flow passage 53 communicates to the master pressure pipe 11, and the master cylinder pressure sensor 102 thus detects the master cylinder pressure Pmc1. In this case, it should be understood that the present invention can also be carried out so that the master cylinder pressure sensor 102 is provided to the master pressure flow passage 54 on an upstream side with respect to the location where the master cut valve 64 is provided so as to detect even the master cylinder pressure Pmc (namely, the master cylinder pressure Pmc2). The master cylinder pressure sensor 102 outputs a signal representing the detected master cylinder pressure Pmc (master cylinder pressure Pmc1) to the brake ECU 100. The control pressure sensor 103 outputs a signal representing the control pressure Px (corresponding to the wheel cylinder pressure at each wheel cylinder 42) which is a hydraulic pressure of the working fluid in the main flow passage 52 to the brake ECU 100.

Moreover, a stroke sensor 104 as stroke detection means provided on the brake pedal 10 is connected to the brake ECU 100. The stroke sensor 104 outputs to the brake ECU 100 a signal representing a pedal stroke which is a stepping amount (operation amount) of the pedal 10 by the driver, namely, a total stroke Sm of movable parts (such as a stoke of the pressurizing piston 22a, a deflection of the stroke adjustment spring 22d, and a stroke of the piston 70a in the stroke simulator 70) constructing the master cylinder 22 coupled to the brake pedal 10. Moreover, a wheel speed sensor 105 is connected to the brake ECU 100. The wheel speed sensor 105 detects a wheel speed Vx, which is a rotational speed of the front and rear right and left wheels, and outputs the signal representing the detected wheel speed Vx to the brake ECU 100. Further, an indicator 106 for notifying the driver of an abnormality occurring on the brake device is connected to the brake ECU 100. The indicator 106 follows the control by the brake ECU 100, and notifies the driver of the abnormality occurring on the brake device as described later.

A description is now given of brake control carried out by the brake ECU 100. The brake ECU 100 selectively carries out the brake control in at least two control modes including a linear control mode (4S mode) of adjusting the hydraulic pressure (more specifically, the accumulator pressure Pacc) output from the power hydraulic pressure generation device 30 by using the linear control valve 65, and transmitting the adjusted hydraulic pressure to the respective wheel cylinders 42, and a backup mode (2S mode) of transmitting the hydraulic pressure (more specifically, the master cylinder pressure Pmc) generated in the master cylinder 22 by the stepping force F by the driver to the front right and left wheel cylinders 42FR and 42FL independently of the rear right and left wheels. The backup mode does not directly relate to the present invention, and a description thereof is thus omitted.

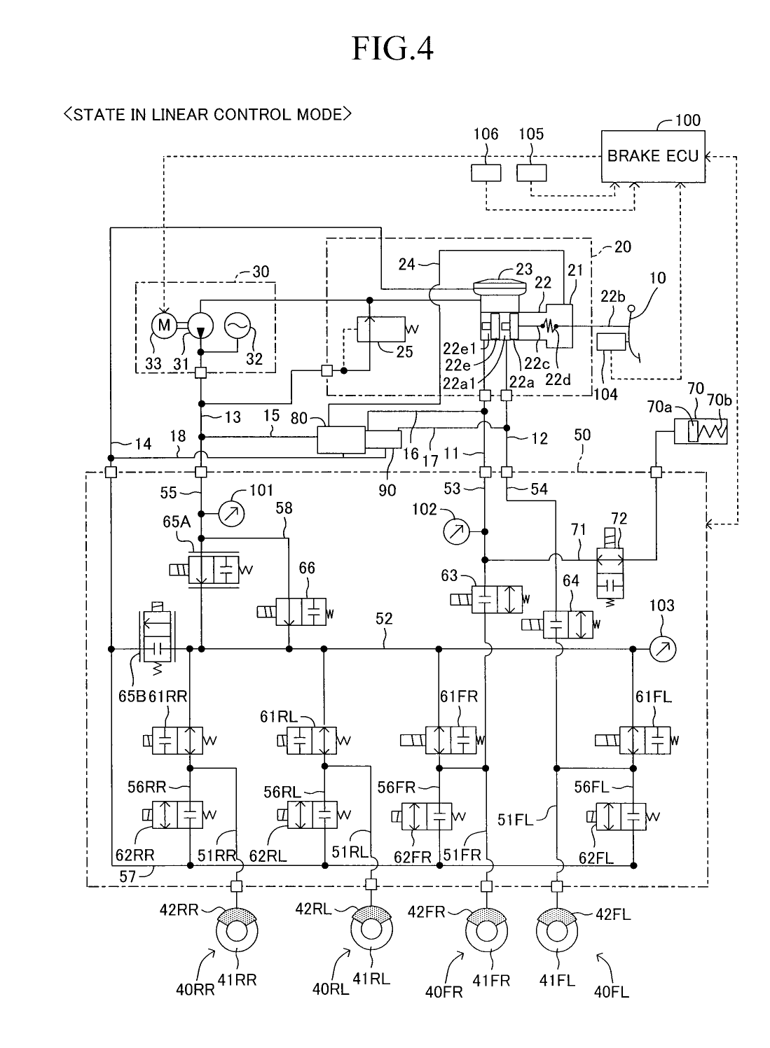

As illustrated in FIG. 4, in the linear control mode, the brake ECU 100 maintains each of the normally-open master cut valves 63 and 64 in the closed state by the current supply to the solenoids, and maintains the simulator cut valve 72 in the open state by the current supply to the solenoid. Moreover, the brake ECU 100 controls the current supply amounts (current values) to the solenoids of the pressure increasing linear control valve 65A and the pressure decreasing linear control valve 65B so as to have the opening degrees corresponding to the current supply amounts, and, if necessary, maintains the adjusted flow rate cut valve 66 in the open state by the current supply to the solenoid.

Further, the brake ECU 100 maintains the normally-closed holding valves 61FR and 61FL in the open state by the current supply to the solenoids, maintains the normally-open holding valves 61RR and 61RL in the open state, and maintains the normally-closed pressure decreasing valves 62FR, 62FL, 62RR, and 62RL in the closed state. Although a detailed description is not given, for example, if the well-known anti-lock brake control based on the wheel speed Vx detected by the wheel speed sensor 105 is necessary to carry out, the brake ECU 100 controls the current supply to the respective solenoids of the holding valves 61 and the pressure decreasing valves 62 based on the anti-lock brake control, thereby bringing the holding valves 61 and the pressure decreasing valves 62 into the open state or the closed state.

The open state and the closed state of each of the valves constructing the hydraulic pressure control valve device 50 are controlled in this way. Thus, both the master cut valves 63 and 64 are maintained in the closed state in the linear control mode, and hence the hydraulic pressures (namely, the master cylinder pressures Pmc1 and Pmc2) output from the master cylinder unit 20 are not transmitted to the wheel cylinders 42. On the other hand, the pressure increasing linear control valve 65A and the pressure decreasing linear control valve 65B are in the current supply control state of the solenoids, and hence the hydraulic pressure (namely, the accumulator pressure Pacc) output from the power hydraulic pressure generation device 30 is adjusted by the pressure increasing linear control valve 65A and the pressure decreasing linear control valve 65B, and is transmitted to the wheel cylinders 42 at the four wheels. In this case, the holding valves 61 are maintained in the open state, and the pressure decreasing valves 62 are maintained in the closed state, and hence the wheel cylinders 42 each communicate to the main flow passage 52, and all the wheel cylinder pressures have the same value at the four wheels. The wheel cylinder pressure can be detected by the control pressure sensor 103 as the control pressure Px.

By the way, the vehicle on which the brake device according to this embodiment is installed may be, for example, an electric vehicle (EV) including a running motor driven by a battery power supply, a hybrid vehicle (HV) including an internal combustion engine in addition to the running motor, and a plug-in hybrid vehicle (PHV) which is a hybrid vehicle (HV) further including a battery rechargeable by using an external power supply. Each of those vehicles can carry out regenerative braking in the following manner. Electric power is generated by converting rotational energy of the wheels into electric energy by the running motor, thereby generating electricity, and the battery is charged by using the generated electric power, thereby acquiring a braking force. If the regenerative braking is carried out, a braking force is generated by the brake device, which is acquired by subtracting a regenerative braking force amount from a total braking force required for braking the vehicle, thereby carrying out brake regeneration cooperative control by using both the regenerative braking and the hydraulic braking.

Specifically, the brake ECU 100 receives a braking request, and then starts the brake regeneration cooperative control. The braking request is generated when the braking force needs to be applied to the vehicle, for example, when the driver carries out the stepping operation (hereinafter also simply referred to as “brake operation”) on the brake pedal 10, or when automatic braking is requested to be operated. On this occasion, when the driver carries out the stepping operation on the brake pedal 10, the master cylinder pressure Pmc1 is supplied via the master pressure pipe 11 and the first master pressure supply passage 16 to the small diameter chamber 94 of the separation valve mechanism 90, namely, the small diameter chamber 84 of the pressure increasing mechanism 80, and the master cylinder pressure Pmc2 is supplied via the master pressure pipe 12 and the second master pressure supply passage 17 to the large diameter chamber 93 of the separation valve mechanism 90. As a result, the stepped piston 92 moves forward in the separation valve mechanism 90 to press the large diameter side of the stepped piston 83 of the pressure increasing mechanism 80, and the stepped piston 82 moves forward toward the small diameter chamber 84 to compress the working fluid in the small diameter chamber 84 by the master cylinder pressure Pmc1 supplied to the large diameter chamber 83 and the pressing by the stepped piston 92 of the separation valve mechanism 90 in the pressure increasing mechanism 80. As a result, the servo pressure Ps is supplied from the pressure increasing mechanism 80 to the hydraulic pressure booster 21 via the servo pressure pipe 24, and the stepping operation on the brake pedal 10 by the driver is assisted. Moreover, the automatic brake may be operated in traction control, vehicle stability control, headway distance control, and collision prevention control, and if start conditions for those pieces of control are satisfied, the braking request is generated.

When the brake ECU 100 receives the braking request, the brake ECU 100 acquires at least one of the master cylinder pressure Pmc1 detected by the master cylinder pressure sensor 102 or the stroke Sm detected by the stroke sensor 104 as the brake operation amount, and calculates a target braking force which increases along with an increase in the master cylinder pressure Pmc1 and/or the stroke Sm. Regarding the brake operation amount, the present invention can also be carried out so that the target braking force is calculated based on, for example, a stepping force F on the brake pedal 10 acquired by providing a stepping force sensor for detecting the stepping force F in place of the acquisition of the master cylinder pressure Pmc1 and/or the stroke Sm.

Then, the brake ECU 100 transmits information representing the calculated target braking force to a hybrid ECU (not shown) in the brake regeneration cooperative control. The hybrid ECU calculates the braking force generated by the power regeneration among the target braking forces, and transmits information representing the regenerative braking force, which is a calculation result, to the brake ECU 100. As a result, the brake ECU 100 can calculate the target hydraulic pressure braking force, which is the braking force to be generated on the brake device, by subtracting the regenerative braking force from the target braking force. The regenerative braking force generated by the power regeneration carried out by the hybrid ECU is changed not only by a change in the rotational speed of the motor but also by the regenerative power control depending on a charged state (SOC: state of charge) of the battery. Thus, an appropriate target hydraulic pressure braking force can be calculated by subtracting the regenerative braking force from the target braking force.

The brake ECU 100 calculates, based on the calculated target hydraulic pressure braking force, a target hydraulic pressure for each of the wheel cylinders 42 corresponding to the target hydraulic pressure braking force, and controls the drive currents for the pressure increasing linear control valve 65A and the pressure decreasing linear control valve 65B by feedback control so that the wheel cylinder pressure is equal to the target hydraulic pressure. In other words, the brake ECU 100 controls the current supply amounts (current values) for the solenoids of the pressure increasing linear control valve 65A and the pressure decreasing linear control valve 65B so that the control pressure Px (=wheel cylinder pressure) detected by the control pressure sensor 103 follows the target hydraulic pressure.

As a result, the working fluid is supplied from the power hydraulic pressure generation device 30 via the pressure increasing linear control valve 65A and, if necessary, via the adjusted flow rate cut valve 66 to the respective wheel cylinders 42, resulting in generation of the braking forces on the wheels. Moreover, the working fluid is discharged from the wheel cylinders 42 via the pressure decreasing linear control valve 65B to the reservoir flow passage 57, and the braking forces generated on the respective wheels are thus appropriately adjusted.

Then, for example, when the braking operation by the driver is released, the current supply to the solenoids of all the electromagnetic valves constructing the hydraulic pressure control valve device 50 is shut off, and, finally, all the electromagnetic control valves are returned to original positions illustrated in FIG. 1. Moreover, the stepped piston 82 is returned to the backward movement end in the pressure increasing mechanism 80, and the large diameter chamber 83 and the small diameter chamber 84 communicate to each other via the communication passage 89. Further, in the separation valve mechanism 90, the stepped piston 92 moves backward when the stepped piston 82 of the pressure increasing mechanism 80 moves backward.

All the electromagnetic valves are finally returned to the original positions in this way. Consequently, the hydraulic pressure (working fluid) in the brake cylinder 42FL on the front left wheel is returned via the master cut valve 63 in the open state to the master cylinder 22 and the reservoir 23, and the hydraulic pressure (working fluid) in the brake cylinder 42FR on the front right wheel is returned via the master cut valve 64 in the open state to the master cylinder 22 and the reservoir 23. The hydraulic pressures (working fluid) of the brake cylinder 42RL on the rear left wheel and the brake cylinder 42RR on the rear right wheel are returned respectively via the pressure decreasing valves 62RL and 62RR temporarily brought into the open state and the reservoir flow passage 57 to the reservoir 23.

Note that, the present invention does not always need to carry out the brake regeneration cooperative control, and it should be understood that the present invention can be applied to a vehicle on which the regenerative braking force is not generated. In this case, the target hydraulic pressure only needs to be directly calculated based on the brake operation amount. The target hydraulic pressure is set by using a map, a calculation equation, or the like so as to have a large value as the brake operation amount increases.

By the way, the servo pressure Ps generated by the operations of the pressure increasing mechanism 80 and the separation valve mechanism 90 and supplied via the servo pressure pipe 24 to the hydraulic pressure booster 21 can be used to generate the master cylinder pressures Pmc1 and Pmc2 as described above in the brake operation by the driver. The master cylinder pressures Pmc1 and Pmc2 generated by the brake operation by the driver generally have the same magnitude, and in the following description, the master cylinder pressures Pmc1 and Pmc2 are also collectively referred to as “master cylinder pressure Pmc” if the master cylinder pressures Pmc1 and Pmc2 do not particularly need to be distinguished from each other.

In other words, the driver receives the assist caused by the applied servo pressure Ps, and can carry out the stepping operation on the brake pedal 10 by using a small stepping force F, thereby generating a master cylinder pressure Pmc having an appropriate magnitude. As a result, the brake ECU 100 carries out the above-mentioned operation control on the electromagnetic valves constructing the hydraulic pressure control valve device 50 based on the predetermined relationship between the master cylinder pressure Pmc1 (master cylinder pressure Pmc) detected by the master cylinder pressure sensor 102 and the stroke Sm detected by the stroke sensor 104, thereby generating braking forces intended by the driver, in other words, braking forces with which appropriate braking feeling is secured, by using the brake units 40.

On this occasion, a detailed description is now given of the servo pressure Ps generated by the operations of the pressure increasing mechanism 80 and the separation valve mechanism 90. It is now assumed that the pressure receiving area on the small diameter side (namely, the generation (supply) side of the servo pressure Ps) of the stepped piston 82 of the pressure increasing mechanism 80 is A1 and the pressure receiving area on the large diameter side (namely, the side supplied with the master cylinder pressure Pmc1) is A2. Moreover, the pressure receiving area on the small diameter side (namely, the side supplied with the master cylinder pressure Pmc1) of the stepped piston 92 of the separation valve mechanism 90 is B1 and the pressure receiving area on the large diameter side (namely, the side supplied with the master cylinder pressure Pmc2) is B2.

If the magnitudes of the supplied master cylinder pressures Pmc1 and Pmc2 are equal to each other (Pmc1=Pmc2), the balance of the forces acting on the stepped piston 82 of the pressure increasing mechanism 80 and the stepped piston 92 of the separation valve mechanism 90 can be represented by Equation 1.

Ps·A1=Pmc1·A2+(Pmc2·B2−Pmc1·B1) Equation 1

Thus, the servo pressure Ps generated by the operations of the pressure increasing mechanism 80 and the separation valve mechanism 90, namely, the servo pressure Ps generated by the normal operations of the pressure increasing mechanism 80 and the separation valve mechanism 90 illustrated in FIG. 3 can be represented by Equation 2 transformed from Equation 1.

Ps=Pmc1·[(A2+B2−B1)/A1] Equation 2

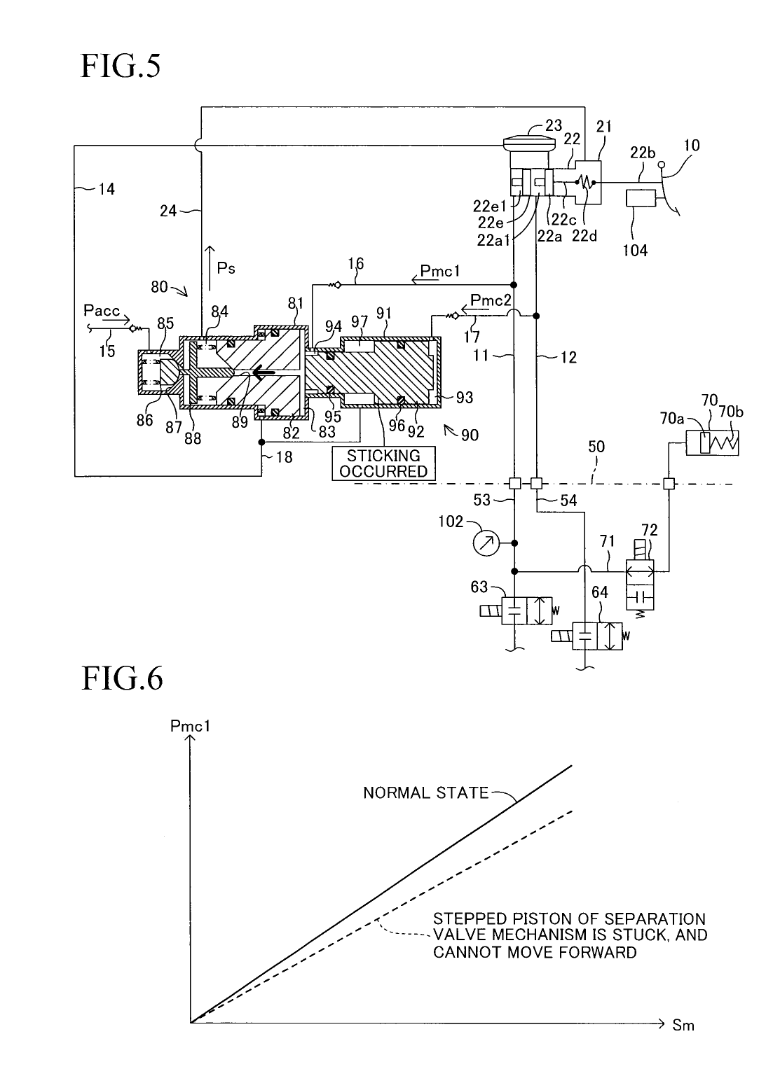

On the other hand, as a state where an abnormality occurs in the operations of the pressure increasing mechanism 80 and the separation valve mechanism 90, and the servo pressure Ps represented by Equation 2 is not acquired, as illustrated in FIG. 5, there can be conceived a state where the stepped piston 92 of the separation valve mechanism 90 is stuck to the housing 91. In the state where the stepped piston 92 is stuck in this way, even if the master cylinder pressure Pmc1 and the master cylinder pressure Pmc2 are supplied, the stepped piston 92 cannot move forward toward the stepped piston 82 of the pressure increasing mechanism 80 (in other words, cannot press the stepped piston 82). Thus, the force applied to the large diameter side of the stepped piston 82 of the pressure increasing mechanism 80 decreases compared with that in the normal state.

Therefore, in the state where the stepped piston 92 is stuck, the servo pressure Ps is generated by the forward movement of the stepped piston 82 of the pressure increasing mechanism 80 caused by the master cylinder pressure Pmc1 supplied to the large diameter chamber 83 without consideration of the force (pressing force) applied by the stepped piston 92, and can thus be represented by Equation 3.

Ps=Pmc1·A2/A1 Equation 3

In other words, when the stepped piston 92 of the separation valve mechanism 90 is stuck, as apparent from a comparison between Equation 2 representing the servo pressure Ps in the normal state and Equation 3, the servo pressure Ps supplied to the hydraulic pressure booster 21 decreases. Even if the stepped piston 92 of the separation valve mechanism 90 is stuck, regardless of whether or not the stepped piston 92 is stuck, if the stroke Sm changes (in other words, the pressurizing piston 22a strokes), the master cylinder pressure Pmc (master cylinder pressure Pmc1) changes. In other words, even if the stepped piston 92 of the separation valve mechanism 90 is stuck, such a state that the master cylinder pressure Pmc from the master cylinder 22 does not change with respect to a change (increase) in the stroke Sm in the master cylinder 22, so-called an ineffective stroke, does not occur.

On this occasion, as described above, the first piston rod 22b coupled to the brake pedal 10 and the second piston rod 22c coupled to the pressurizing piston 22a are coupled to each other via the stroke adjustment spring 22d in the master cylinder 22 according to this embodiment. As a result, a different relationship between the stroke Sm of the master cylinder 22 and the master cylinder pressure Pmc (master cylinder pressure Pmc1 or the master cylinder pressure Pmc2) output from the master cylinder 22 can be defined depending on the magnitude of the servo pressure Ps supplied to the hydraulic pressure booster 21 as described later. Thus, if the stepped piston 92 of the separation valve mechanism 90 is stuck, the servo pressure Ps decreases compared with that in the normal state, and the relationship between the stroke Sm of the master cylinder 22 and the master cylinder pressure Pmc (master cylinder pressure Pmc1) can be defined as shown in FIG. 6.

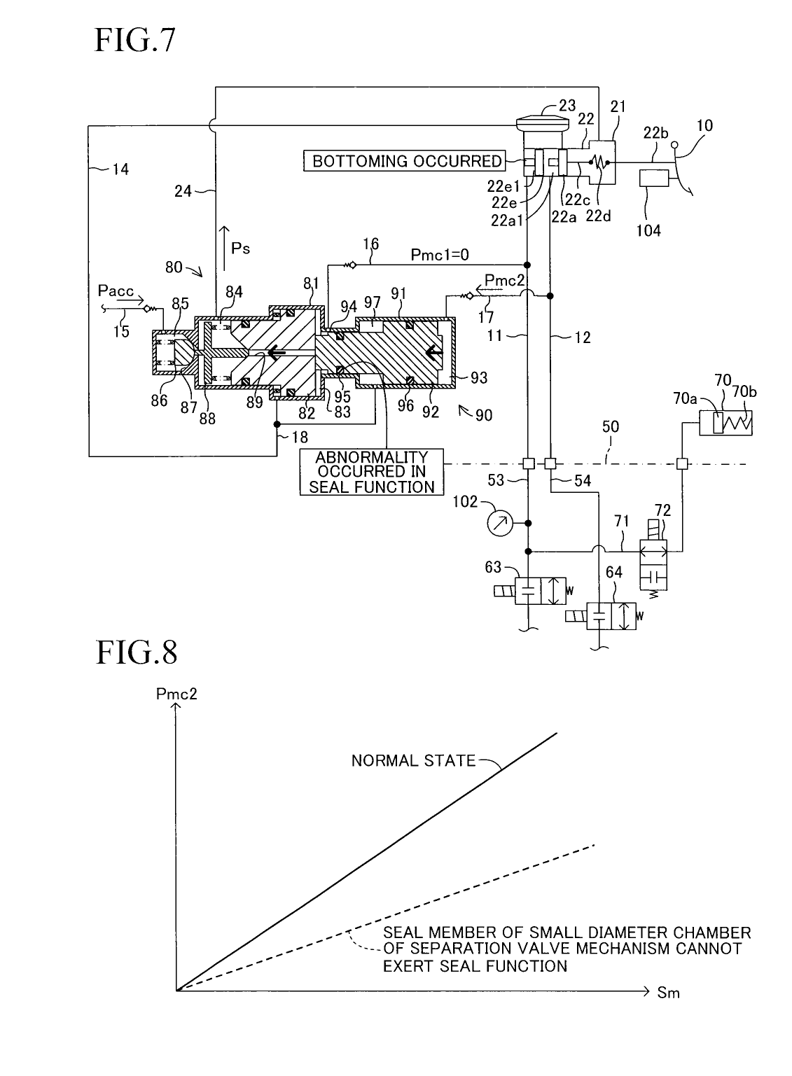

Moreover, as another state where an abnormality occurs in the operations of the pressure increasing mechanism 80 and the separation valve mechanism 90, and the servo pressure Ps represented by Equation 2 is not acquired, as illustrated in FIG. 7, there can be conceived a state where the seal member 95 for partitioning the small diameter chamber 94 of the separation valve mechanism 90 cannot exert the seal function. In this way, in a case where the seal member 95 of the small diameter chamber 94 is worn and thus cannot exert the seal function, for example, even if the working fluid is supplied from the master pressure pipe 11 via the master pressure supply passage 16 to the small diameter chamber 94, the supplied working fluid flows out to the reservoir chamber 97. Then, the working fluid which has flown out to the reservoir chamber 97 is returned via the reservoir passage 18 and the reservoir flow passage 14 to the reservoir 23. As a result, the hydraulic pressure in the small diameter chamber 94, namely, the master cylinder pressure Pmc1 in the master pressure pipe 11 communicating to the small diameter chamber 94, which is detected by the master cylinder pressure sensor 102, does not increase. Moreover, the master cylinder pressure Pmc1 does not increase in the large diameter chamber 83 of the pressure increasing mechanism 80 communicating to the small diameter chamber 94 of the separation valve mechanism 90, and hence the stepped piston 82 does not move forward. Further, in the state where the small diameter chamber 94 and the reservoir 23 communicate to each other in this way, the pressurizing piston 22e for generating the master cylinder pressure Pmc1 moves forward until bottoming occurs in the master cylinder 22, and the stroke Sm detected by the stroke sensor 104 in this case is an ineffective stroke.

On the other hand, if the master cylinder pressure Pmc2 is supplied from the master pressure pipe 12 via the master pressure supply passage 17 to the large diameter chamber 93, as illustrated in FIG. 7, the stepped piston 92 of the separation valve mechanism 90 can move forward toward the stepped piston 82 of the pressure increasing mechanism 80 by the supplied master cylinder pressure Pmc2, and can press the stepped piston 82. However, because the pressure receiving area B2 on the large diameter side of the stepped piston 92 of the separation valve mechanism 90 is smaller than the pressure receiving area A2 on the large diameter side of the stepped piston 82 of the pressure increasing mechanism 80, the force applied to the large diameter side of the stepped piston 82 of the pressure increasing mechanism 80 decreases compared with that in the normal state.

Therefore, the servo pressure Ps, which is generated in the state where the seal member 95 of the small diameter chamber 94 of the separation valve mechanism 90 cannot exert the seal function, is generated only by the pressing by the stepped piston 92 of the separation valve mechanism 90 moved forward by the forward movement of the stepped piston 82 of the pressure increasing mechanism 80 by the master cylinder pressure Pmc2, while the master cylinder pressure Pmc1 supplied to the small diameter chamber 94 of the separation valve mechanism 90 and the large diameter chamber 83 of the pressure increasing mechanism 80 is “0”. The servo pressure Ps can thus be represented by Equation 4.

Ps=Pmc2·B2/A1 Equation 4

Thus, when the seal member 95 of the small diameter chamber 94 of the separation valve mechanism 90 cannot exert the seal function, the servo pressure Ps decreases compared with that in the normal state, and hence the relationship between the stroke Sm of the master cylinder 22 and the master cylinder pressure Pmc (master cylinder pressure Pmc2) can be defined as shown in FIG. 8.

In this case, the master cylinder pressure Pmc2 cannot be detected by the master cylinder pressure sensor 104 in a strict sense. Therefore, the relationship shown in FIG. 8 is set in advance, and when the seal member 95 of the small diameter chamber 94 of the separation valve mechanism 90 cannot exert the seal function, and a linear control continuation program described later is executed, the master cylinder pressure Pmc2, namely, the master cylinder Pmc can be determined from the stroke Sm detected by the stroke sensor 104.

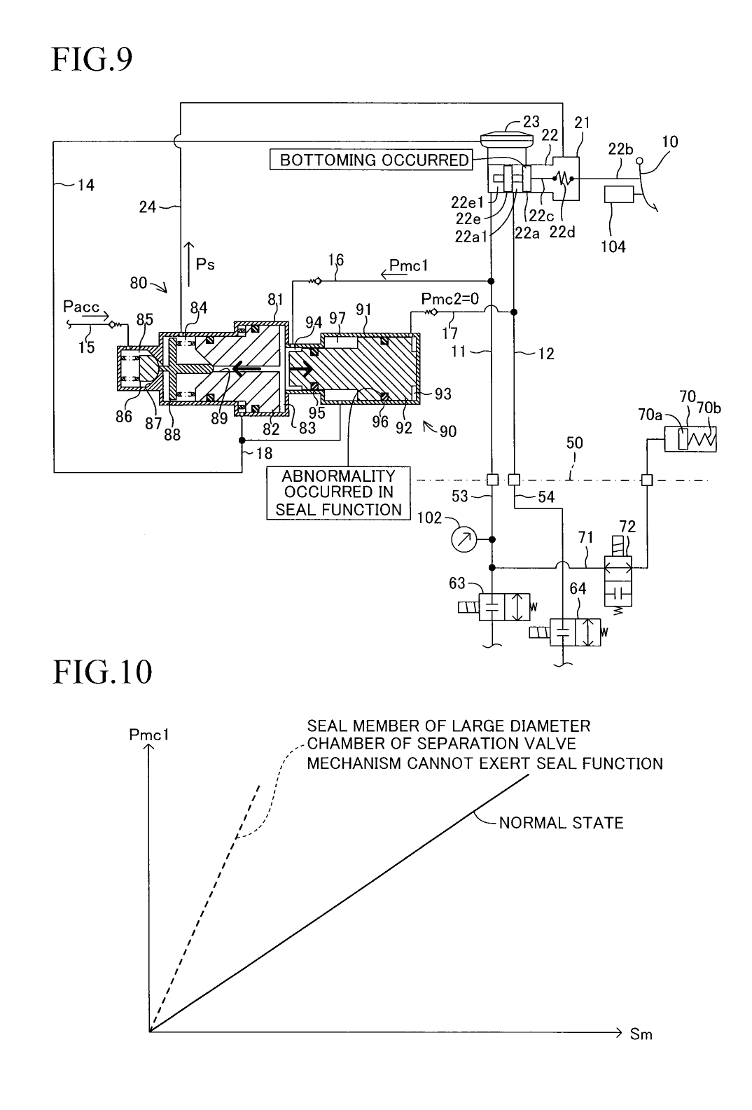

Further, as another state where an abnormality occurs in the operations of the pressure increasing mechanism 80 and the separation valve mechanism 90 and thus the servo pressure Ps represented by Equation 2 is not acquired, as illustrated in FIG. 9, there can be conceived a state where the seal member 96 for partitioning the large diameter chamber 93 of the separation valve mechanism 90 cannot exert the seal function. When the seal member 96 of the large diameter chamber 93 is worn and thus cannot exert the seal function in such state, for example, even if the working fluid is supplied from the master pressure pipe 12 via the master pressure supply passage 17 to the large diameter chamber 93, the supplied working fluid flows out to the reservoir chamber 97. Then, the working fluid which has flown out to the reservoir chamber 97 is returned via the reservoir passage 18 and the reservoir flow passage 14 to the reservoir 23. As a result, the master cylinder pressure Pmc2 in the large diameter chamber 93 does not increase, and becomes “0”. Moreover, in the state where the large diameter chamber 93 and the reservoir 23 communicate to each other in this way, the pressurizing piston 22a for generating the master cylinder pressure Pmc2 moves forward until the pressurizing piston 22a is brought into abutment against the pressurizing piston 22e, that is, until bottoming occurs in the master cylinder 22. The stroke Sm detected by the stroke sensor 104 in this case is an ineffective stroke.

On the other hand, when the master cylinder pressure Pmc1 is supplied from the master pressure pipe 11 via the master pressure supply passage 16 to the small diameter chamber 94 of the separation valve mechanism 90 and the large diameter chamber 83 of the pressure increasing mechanism 80, as illustrated in FIG. 9, the stepped piston 82 of the pressure increasing mechanism 80 can move forward, thereby generating the servo pressure Ps. However, the stepped piston 92 of the separation valve mechanism 90 moves backward in a direction separating from the stepped piston 83 of the pressure increasing mechanism 80 by the master cylinder pressure Pmc1 supplied to the small diameter chamber 94. Thus, the stepped piston 92 of the separation valve mechanism 90 does not apply the pressing, and the force applied to the large diameter side of the stepped piston 82 of the pressure increasing mechanism 80 thus decreases compared with that in the normal state.

Therefore, in the state where the seal member 96 for partitioning the large diameter chamber 93 of the separation valve mechanism 90 cannot exert the seal function, the servo pressure Ps is generated by the forward movement of the stepped piston 82 of the pressure increasing mechanism 80 by the master cylinder pressure Pmc1 supplied to the large diameter chamber 83 without consideration of the force (pressing force) applied by the stepped piston 92. The servo pressure Ps can thus be represented by Equation 3. In this case, when the seal member 96 of the large diameter chamber 93 of the separation valve mechanism 90 cannot exert the seal function, the servo pressure Ps decreases compared with that in the normal state as described above, and the relationship between the stroke Sm of the master cylinder 22 and the master cylinder pressure Pmc (master cylinder pressure Pmc1) can be defined as shown in FIG. 10. In other words, when the seal member 96 of the large diameter chamber 93 of the separation valve mechanism 90 cannot exert the seal function, an ineffective stroke is generated, and hence a relationship between the stroke Sm of the master cylinder 22 and the master cylinder pressure Pmc1 considering the ineffective stroke is defined.

Specifically, in the state where the ineffective stroke is generated, the master cylinder pressure Pmc1 needs to be generated by an effective stroke Sm acquired by subtracting the ineffective stroke from a permissible stroke set for the master cylinder 22. In other words, when the ineffective stroke is considered, a change in (gradient of) the master cylinder pressure Pmc1 with respect to a change in the stroke Sm increases. Thus, when the seal member 96 of the large diameter chamber 93 of the separation valve mechanism 90 cannot exert the seal function, the relationship between the stroke Sm of the master cylinder 22 and the master cylinder pressure Pmc (master cylinder pressure Pmc1) is defined as shown in FIG. 10.

A brief description is now given of the relationship between the stroke Sm of the master cylinder 22 and the master cylinder pressure Pmc1, which can be defined as described before. For easy understanding, like components are hereinafter denoted by like numerals as those of the above-mentioned master cylinder unit 20.

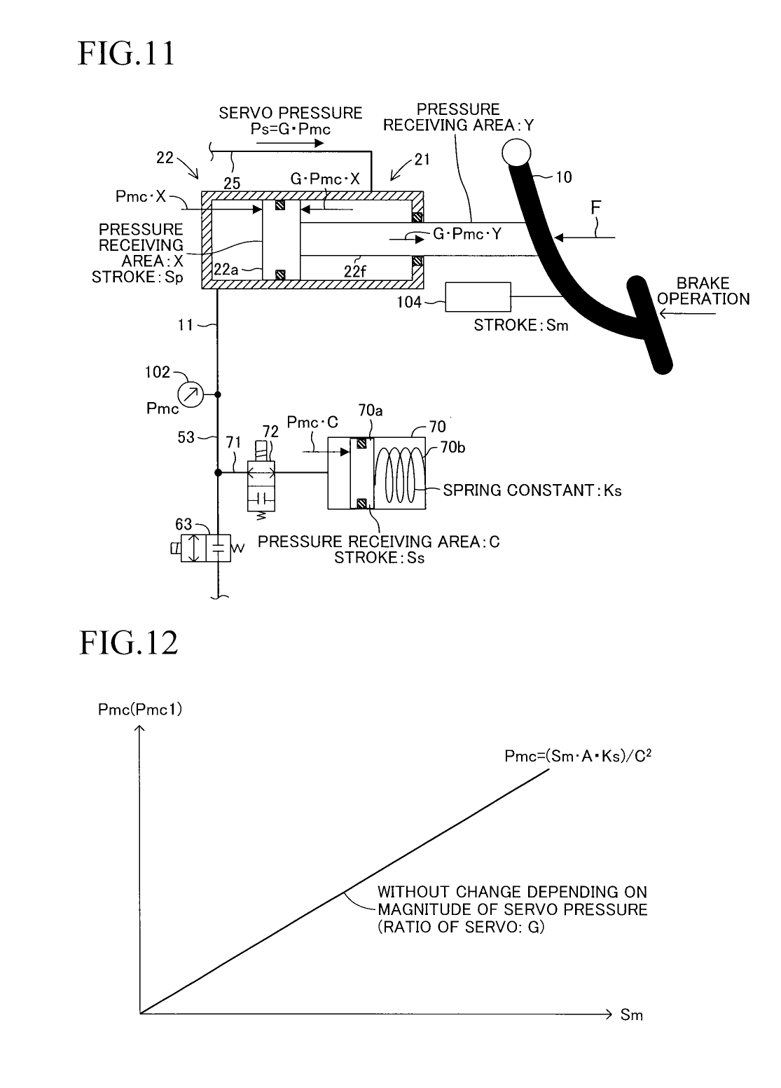

A configuration of the master cylinder unit 20 illustrated in FIG. 11 is now assumed. Specifically, in the assumed master cylinder unit 20, the pressurizing piston 22a and the brake pedal 10 are connected to each other by using only the piston rod 22f, in other words, are directly connected to each other without providing the first piston rod 22b, the second piston rod 22c, and the stroke adjustment spring 22d. In the following, for the sake of simple description, the pressurizing piston 22e and the master pipe 12 are omitted.

In the above-mentioned configuration of the master cylinder unit 20, as illustrated in FIG. 11, the pressure receiving area and the stroke of the pressurizing piston 22a of the master cylinder unit 20 are respectively denoted by “X” and “Sp”, the pressure receiving area of the piston rod 22f (corresponding to the first piston rod 22b) is denoted by “Y”, the pressure receiving area and the stroke of the piston 70a of the stroke simulator 70 are respectively denoted by “Z” and “Ss”, and the spring constant of the spring 70b is denoted by “Ks”. In this configuration, as illustrated in FIG. 11, regarding a state where the servo pressure Ps (=G·Pmc1) is supplied via the servo pressure pipe 24 to the hydraulic pressure booster 21 as a result of the operations of the pressure increasing mechanism 80 and the separation valve mechanism 90, a relationship between the master cylinder pressure Pmc (master cylinder pressure Pmc1) output from the master cylinder 22 and the stroke Sm is considered. Note that, G in the servo pressure Ps=G·Pmc1 represents a ratio of the servo pressure to the master cylinder pressure Pmc1.

Regarding the relationship between the master cylinder pressure Pmc (master cylinder pressure Pmc1) and the stroke Sm in the above-mentioned configuration, when the stepping operation is carried out on the brake pedal 10 and the pressurizing piston 22a coupled to the piston rod 22f strokes, the master cylinder pressure Pmc1 is generated. In this case, in the above-mentioned configuration, the magnitude of the servo pressure Ps does not affect the stroke of the pressurizing piston 22a, namely, the stroke Sm of the master cylinder 22. Thus, as illustrated in FIG. 11, Equation 5 holds true by considering the Pascal's theorem established between the master cylinder 22 and the stroke simulator 70 coupled to each other via the master pressure pipe 11 and the force balance therebetween.

Pmc=(Sm·X·Ks)/Z2 Equation 5

As a result, when the brake pedal 10 and the pressurizing piston 22a are directly coupled to each other via the piston rod 22f, as shown in FIG. 12, regardless of the magnitude of the servo pressure Ps, the master cylinder pressure Pmc (master cylinder pressure Pmc1) and the stroke Sm are in a proportional relationship following Equation 5.

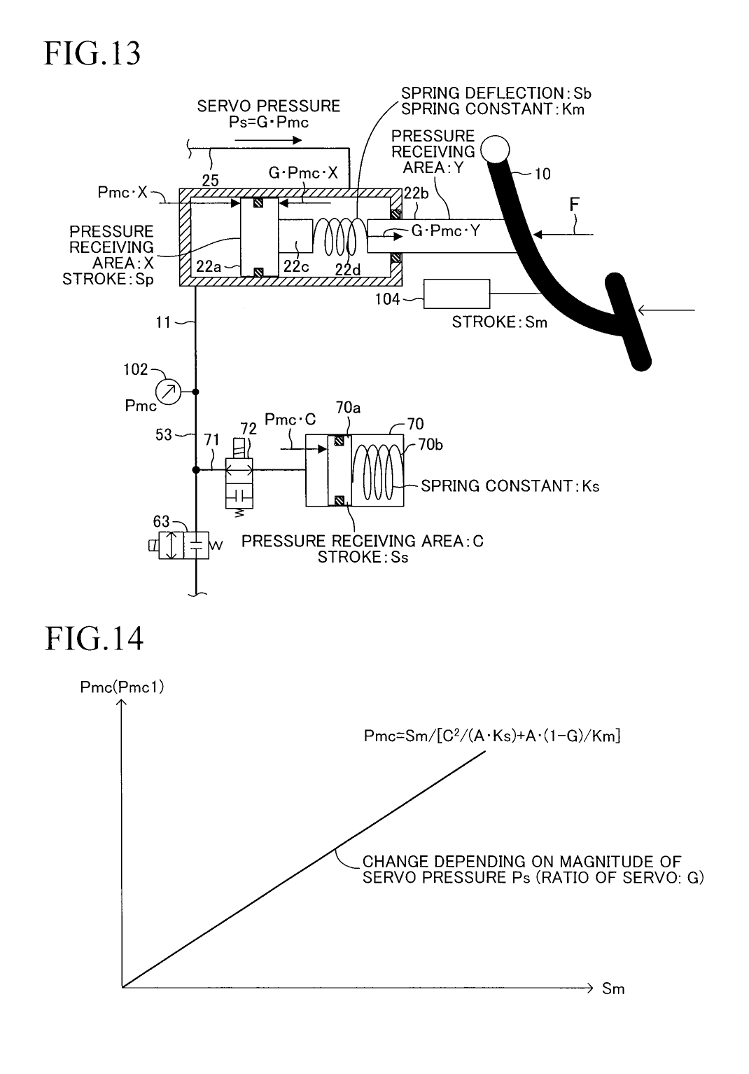

In contrast, as illustrated in FIG. 13 in detail, in the master cylinder unit 20 according to this embodiment, the pressurizing piston 22a of the master cylinder 22 is coupled to the brake pedal 10 via the first piston rod 22b, the stroke adjustment spring 22d, and the second piston rod 22c. As a result, the relationship between the master cylinder pressure Pmc (master cylinder pressure Pmc1) and the stroke Sm can be changed and defined depending on the magnitude of the servo pressure Ps. A detailed description is now given of the relationship. In the following, as illustrated in FIG. 13, the pressure receiving area of the first piston rod 22b is denoted by “Y”, and the spring deflection and the spring constant of the stroke adjustment spring 22d are respectively denoted by “Sb” and “Km”.

In this embodiment, the total stroke Sm of the master cylinder 22 is a sum of the stroke Sp of the pressurizing piston 22a and the spring deflection Sb of the stroke adjustment spring 22d. Thus, before a description is given of the relationship between the master cylinder pressure Pmc (master cylinder pressure Pmc1) and the stroke Sm according to this embodiment, first, the relationship between the master cylinder pressure Pmc of the master cylinder 22 and the stroke Sp of the pressurizing piston 22a is represented by Equation 6 based on the force balance between the master cylinder 22 and the stroke simulator 70 regardless of the magnitude of the servo pressure Ps.

Sp=(Pmc·Z²)/(X·Ks) Equation 6

As a result, even when the stroke adjustment spring 22d is provided between the brake pedal 10 and the pressurizing piston 22a, regardless of the magnitude of the servo pressure Ps, the master cylinder pressure Pmc1 (master cylinder pressure Pmc1) and the stroke Sp are in a proportional relationship following Equation 6.

Moreover, a relationship between the master cylinder pressure Pmc of the master cylinder 22 and the spring deflection Sb of the stroke adjustment spring 22d changes depending on the magnitude of the servo pressure Ps, and is represented by Equation 7 based on the force balance.

Sb=(Pmc·X)·(1−G)/Km Equation 7

Note that, a relationship of 1>G holds true in Equation 7.

As a result, when the stroke adjustment spring 22d is provided between the brake pedal 10 and the pressurizing piston 22a, as apparent from Equation 7, as the servo pressure Ps (ratio G of the servo pressure) increases, the spring deflection Sb in a proportional relationship having a smaller gradient with the change in the master cylinder pressure Pmc (master cylinder pressure Pmc1) is generated, and as the servo pressure Ps (ratio G of the servo pressure) decreases, the spring deflection Sb in a proportional relationship having a larger gradient with the change in the master cylinder pressure Pmc (master cylinder pressure Pmc1) is generated.

Then, as described above, in this embodiment in which the stroke adjustment spring 22d is provided in the master cylinder 22, the total stroke Sm of the master cylinder 22 is the sum of the stroke Sp of the pressurizing piston 22a and the spring deflection Sb of the stroke adjustment spring 22d. Thus, the relationship between the master cylinder pressure Pmc (master cylinder pressure Pmc1) and the stroke Sm is represented by Equation 8.

Pmc=Sm/[C²/(A·Ks)+A·(1−G)/Km] Equation 8

As a result, when the stroke adjustment spring 22d is provided in the master cylinder 22, as shown in FIG. 14, the relationship changes depending on the magnitude of the servo pressure Ps (ratio of the servo pressure), in other words, the master cylinder pressure Pmc and the stroke Sm are in a proportional relationship following Equation 8. In other words, when the stroke adjustment spring 22d is provided in the master cylinder 22, the relationship between the master cylinder pressure Pmc (master cylinder pressure Pmc1) and the stroke Sm can be changed and defined depending on the magnitude of the servo pressure Ps (ratio G of the servo pressure).

Note that, in general, the relationship between the stepping force F input by the driver via the brake pedal 10 and the stroke Sm in the master cylinder 22 changes along with the change in the servo pressure Ps. In other words, in the configuration of the master cylinder unit 20 illustrated in FIG. 11, when the servo pressure Ps decreases, the driver needs to input a larger stepping force F for the same stroke Sm.

On the other hand, in this embodiment in which the stroke adjustment spring 22d is provided between the brake pedal 10 and the pressurizing piston 22a, as described above, the total stroke Sm in the master cylinder 22 is the sum of the stroke Sp of the pressurizing piston 22a and the spring deflection Sb of the stroke adjustment spring 22d. Thus, when the spring constant Km of the stroke adjustment spring 22d is appropriately set, the change in the stepping force F along with the change in the servo pressure Ps can be absorbed, and degradation in the brake operation feeling when the driver carries out the stepping operation on the brake pedal 10 can be made less insensible.

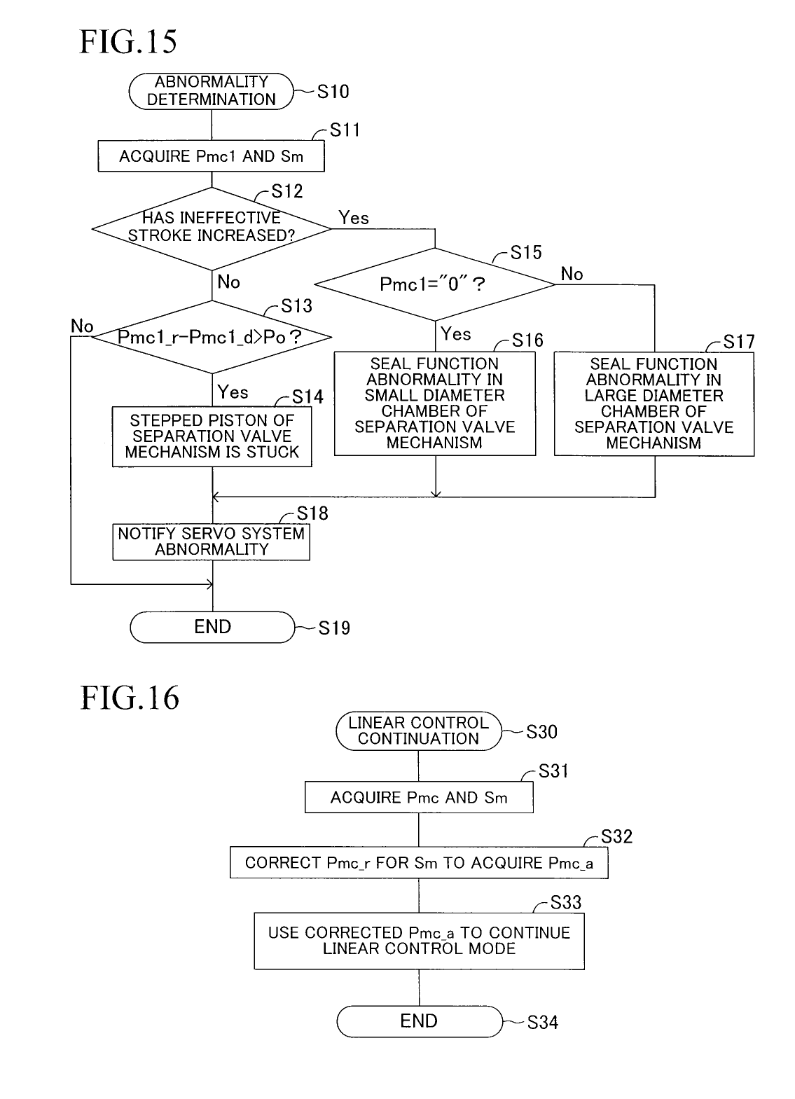

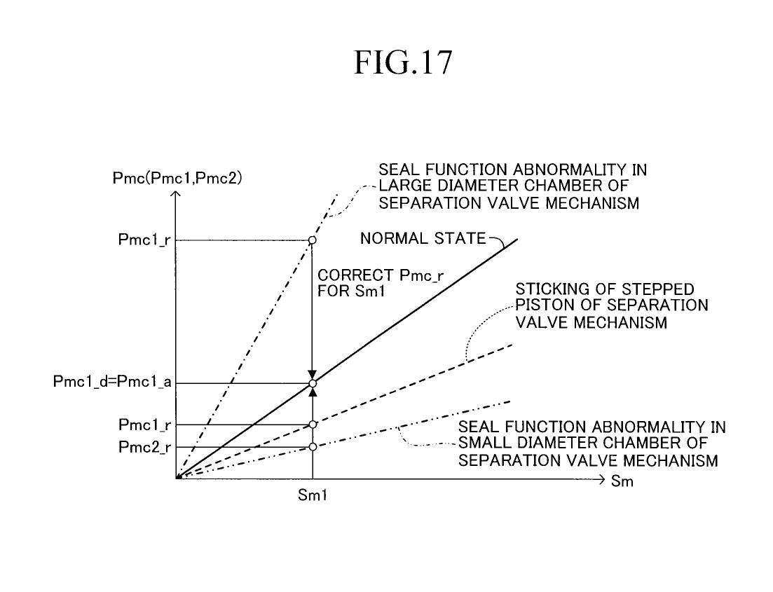

In this way, when an abnormality occurs in the operation of the separation valve mechanism 90, the servo pressure Ps represented by Equation 2 is no longer acquired. However, the relationship between the master cylinder pressure Pmc (master cylinder pressure Pmc1) and the stroke Sm can be changed and defined depending on the magnitude of the servo pressure Ps (ratio G of the servo pressure). Thus, the brake ECU 100 executes an abnormality determination program illustrated in FIG. 15 to determine the abnormality in the servo system in which the servo pressure Ps represented by Equation 2 is not acquired, namely, the operation abnormality in the separation valve mechanism 90. Moreover, when the brake ECU 100 determines an abnormality in the servo system by executing the abnormality determination program shown in FIG. 17, the brake ECU 100 executes the linear control continuation program illustrated in FIG. 16 to continue the linear control mode using the accumulator pressure Pacc by the power hydraulic pressure generation device 30. A detailed description is now given of the abnormality determination program and the linear control continuation program.

First, a description is given of the abnormality determination program. When an ignition switch (or a start switch) (not shown) is operated to an ON state, in Step S10, the brake ECU 100 starts the execution of the abnormality determination program illustrated in FIG. 15. Then, in Step S11, the brake ECU 100 acquires the signal representing the master cylinder pressure Pmc1 from the master cylinder pressure sensor 102, and acquires the signal representing the total stroke Sm of the master cylinder 22 from the stroke sensor 104. Then, after the brake ECU 100 acquires the signal representing the master cylinder pressure Pmc1 and the signal representing the stroke Sm, the brake ECU 100 proceeds to Step S12.

In Step S12, the brake ECU 100 determines whether the ineffective stroke has increased or not based on a change in the stroke Sm and a change in the master cylinder pressure Pmc1 represented by the signals acquired in Step S11. In other words, when the master cylinder pressure Pmc1 has uniformly increased as the stroke Sm has increased, and the ineffective stroke has thus not increased, the brake ECU 100 makes a determination of “No”, and proceeds to Step S13. On the other hand, when the master cylinder pressure Pmc1 has not changed as the stroke Sm has increased, and the ineffective stroke has thus increased, the brake ECU 100 makes a determination of “Yes”, and proceeds to Step S15.

In Step S14, in correspondence with the stroke Sm represented by the signal acquired in Step S11, the brake ECU 100 compares a master cylinder pressure Pmc1_d in the normal state and an actual master cylinder pressure Pmc1_r represented by the signal acquired in Step S11. It is known in advance by an experiment that the master cylinder pressure Pmc1_d is generated by receiving the servo pressure Ps supplied from the pressure increasing mechanism 80 and the separation valve mechanism 90 that normally operate. Then, the brake ECU 100 determines whether or not a difference value, which is acquired by subtracting the actual master cylinder pressure Pmc1_r proportional to the stroke Sm from the master cylinder pressure Pmc1_d in the normal state that is proportional to the stroke Sm, is larger than a predetermined value Po.

As described above, when an operation abnormality occurs in the pressure increasing mechanism 80 and the separation valve mechanism 90, for example, as shown in FIG. 6, for the same stroke Sm, the servo pressure Ps is larger in the normal state and the generated master cylinder pressure Pmc1 is thus larger than that in the abnormal state. Therefore, the brake ECU 100 determines whether or not the difference value acquired by subtracting the actual master cylinder pressure Pmc_r from the known master cylinder pressure Pmc_d in the normal state is larger than the predetermined value Po considering the detection error, thereby appropriately determining a change in the servo pressure Ps, namely, a failure (abnormality) in the servo system including the pressure increasing mechanism 80 and the separation valve mechanism 90. Thus, when the difference value acquired by subtracting the actual master cylinder pressure Pmc_r from the known master cylinder pressure Pmc_d in the normal state is larger than the predetermined value Po, the servo pressure Ps is small and a failure (abnormality) occurs in the servo system, and the brake ECU 100 thus makes a determination of “Yes”, and proceeds to Step S14.

On the other hand, when the difference value acquired by subtracting the actual master cylinder pressure Pmc_r from the known master cylinder pressure Pmc_d in the normal state is equal to or less than the predetermined value Po, the servo pressure Ps has an appropriate magnitude and a failure (abnormality) does not occur in the servo system, and the brake ECU 100 thus makes a determination of “No”, and proceeds to Step S19, in which the execution of the abnormality determination program is once finished. Then, after an elapse of a predetermined short period of time, in Step S10, the brake ECU 100 starts again the execution of the abnormality determination program.

In Step S14, the brake ECU 100 identifies such an operation abnormality that the stepped piston 92 in the separation valve mechanism 90 is stuck as the failure (abnormality) currently occurring in the servo system based on the state where the ineffective stroke has not increased, which is determined in the processing of Step S12, and the difference value acquired by subtracting the actual master cylinder pressure Pmc_r from the master cylinder pressure Pmc_d in the normal state is larger than the predetermined value Po, which is determined in the processing of Step S13. Then, after the brake ECU 100 identifies the content of the operation abnormality of the pressure increasing mechanism 80 and the separation valve mechanism 90 in this way, the brake ECU 100 sets the relationship between the master cylinder pressure Pmc (master cylinder pressure Pmc1) and the stroke Sm shown in FIG. 6, and proceeds to Step S18.

On the other hand, when the brake ECU 100 determines that the ineffective stroke has increased in Step S12, the brake ECU 100 proceeds to Step S15. In Step S15, the brake ECU 100 determines whether the master cylinder pressure Pmc1 represented by the signal acquired in Step S11 maintains “0” or not, in other words, whether the master cylinder pressure Pmc1 does not tend to increase. In other words, when it is determined in processing of Step S12 that the master cylinder pressure Pmc1 has maintained “0” (does not tend to increase) while the ineffective stroke has increased, for example, the brake ECU 100 makes a determination of “Yes”, and proceeds to Step S16. On the other hand, when the master cylinder pressure Pmc1 tends to increase from “0”, the brake ECU 100 makes a determination of “No”, and proceeds to Step S17.

In Step S16, the brake ECU 100 identifies, as the failure (abnormality) currently occurring in the servo system, a state where an abnormality occurs in the seal function of the seal member 95 for partitioning the small diameter chamber 94 of the separation valve mechanism 90 based on such a state determined in the processing of Step S12 that the ineffective stroke has increased, and such a state determined in the processing of Step S15 that the master cylinder pressure Pmc1 maintains “0”, that is, does not tend to increase. In this case, when an abnormality occurs in an oil level (reserved amount of the working fluid) detected by an oil level sensor (not shown) provided on the reservoir 23, the brake ECU 100 may make such a determination that an abnormality occurs due to the working fluid leaking from the brake pipe or the like to the outside, in place of such a determination that an abnormality occurs in the seal function of the seal member 95. Then, after the brake ECU 100 identifies the content of the operation abnormality of the pressure increasing mechanism 80 and the separation valve mechanism 90 in this way, the brake ECU 100 sets the relationship between the master cylinder pressure Pmc (master cylinder pressure Pmc2) and the stroke Sm shown in FIG. 8, and proceeds to Step S18.

On the other hand, in Step S17, the brake ECU 100 identifies, as the failure (abnormality) currently occurring in the servo system, a state where an abnormality occurs in the seal function of the seal member 96 for partitioning the large diameter chamber 93 of the separation valve mechanism 90 based on such a state determined in the processing of Step S12 that the ineffective stroke has increased, and such a state determined in the processing of Step S15 that the master cylinder pressure Pmc1 tends to increase. Also in this case, when an abnormality occurs in the oil level (reserved amount of the working fluid) detected by the oil level sensor provided on the reservoir 23, the brake ECU 100 may make such a determination that an abnormality occurs due to the working fluid leaking from the brake pipe or the like to the outside, in place of such a determination that an abnormality occurs in the seal function of the seal member 96. Then, after the brake ECU 100 identifies the content of the operation abnormality of the pressure increasing mechanism 80 and the separation valve mechanism 90, the brake ECU 100 sets the relationship between the master cylinder pressure Pmc (master cylinder pressure Pmc1) and the stroke Sm shown in FIG. 10, and proceeds to Step S18.

In Step S18, the brake ECU 100 notifies the driver of the failure (abnormality) occurring in the servo system via the indicator 106, and in Step S19, finishes the execution of the abnormality determination program. Then, when a failure (abnormality) occurs in the servo system, the brake ECU 100 promptly starts the execution of the linear control continuation program illustrated in FIG. 16.

As a result of the execution of the abnormality determination program described above, when the brake ECU 100 determines that a failure (abnormality) occurs in the servo system, more specifically, determines that an abnormality occurs in the separation valve mechanism 90, the brake ECU 100 executes the linear control continuation program illustrated in FIG. 16, and continues the brake control in the linear control mode even in such a state that the relationship between the master cylinder pressure Pmc (master cylinder pressure Pmc1) and the stroke Sm has changed due to a change (variation) in the servo pressure Ps. Specifically, in Step S30, the brake ECU 100 starts the execution of the linear control continuation program in parallel to the notification processing of Step S18 in the abnormality determination program described above.

Then, in Step S31, the brake ECU 100 acquires again the signal representing the master cylinder pressure Pmc1 from the master cylinder pressure sensor 102, and acquires the signal representing the total stroke Sm from the master cylinder 22 from the stroke sensor 104. Then, after the brake ECU 100 acquires the signal representing the master cylinder pressure Pmc1 and the signal representing the stroke Sm, the brake ECU 100 proceeds to Step S32.

In Step S32, in order to continue the linear control mode, the brake ECU 100 corrects the actual master cylinder pressure Pmc1_r corresponding to the stroke Sm represented by the signal acquired in Step S31 depending on the failure (abnormality) of the servo system identified by the execution of the abnormality determination program, more specifically, depending on the abnormality content of the separation valve mechanism 90. In other words, as shown in FIG. 17 by the solid line, the brake ECU 100 corrects the actual master cylinder pressure Pmc1_r depending on the identified abnormality content of the separation valve mechanism 90 based on the relationship between the known master cylinder pressure Pmc_d (master cylinder pressure Pmc1_d or the master cylinder pressure Pmc2_d) in the normal state and the stroke Sm, thereby acquiring a corrected master cylinder pressure Pmc1_a. A specific description is now given of this processing.

First, a description is given of a case where the abnormality determination program is executed to identify the occurrence of such an operation abnormality that the stepped piston 92 of the separation valve mechanism 90 is stuck as the failure (abnormality) occurring in the servo system. In this case, the brake ECU 100 has set the relationship between the master cylinder pressure Pmc1 and the stroke Sm shown in FIG. 6. Therefore, as shown in FIG. 17, the brake ECU 100 corrects the actual master cylinder pressure Pmc1_r based on the relationship (solid line) in the normal state and a relationship (broken line) in a state where the stepped piston 92 in the separation valve mechanism 90 is stuck. In other words, the brake ECU 100 increases the actual master cylinder pressure Pmc1_r for correction so that the actual master cylinder pressure Pmc1_r matches the master cylinder pressure Pmc1_d in the normal state corresponding to the stroke Sml represented by the signal acquired in Step S31, thereby acquiring the corrected master cylinder pressure Pmc1_a.

A description is now given of a case where the abnormality determination program is executed to identify that an abnormality occurs in the seal function of the seal member 95 for partitioning the small diameter chamber 94 of the separation valve mechanism 90 as the failure (abnormality) occurring in the servo system. In this case, the master cylinder pressure Pmc1 represented by the signal acquired from the master cylinder pressure sensor 102 is “0”, and the brake ECU 100 thus sets the relationship between the master cylinder pressure Pmc2 and the stroke Sm shown in FIG. 8.

Therefore, as shown in FIG. 17, the brake ECU 100 corrects the actual master cylinder pressure Pmc1_r (more specifically, the estimated master cylinder pressure Pmc2) based on the relationship (solid line) in the normal state and a relationship (long dashed double-short dashed line) in the case where an abnormality occurs in the seal function of the seal member 95 for partitioning the small diameter chamber 94 of the separation valve mechanism 90. In other words, the brake ECU 100 increases the actual master cylinder pressure Pmc1_r (more specifically, the estimated master cylinder pressure Pmc2) for correction so as to match the master cylinder pressure Pmc1_d in the normal state corresponding to the stroke Sm1 represented by the signal acquired in Step S31, thereby acquiring the corrected master cylinder pressure Pmc1_a (more specifically, corrected master cylinder pressure Pmc2).

Next, a description is now given of a case where the abnormality determination program is executed to identify that an abnormality occurs in the seal function of the seal member 96 for partitioning the large diameter chamber 93 of the separation valve mechanism 90 as the failure (abnormality) occurring in the servo system. In this case, the brake ECU 100 sets the relationship between the master cylinder pressure Pmc1 and the stroke Sm shown in FIG. 10.

Therefore, as shown in FIG. 17, the brake ECU 100 corrects the actual master cylinder pressure Pmc1_r based on the relationship (solid line) in the normal state and a relationship (dashed-dotted line) in the case where an abnormality occurs in the seal function of the seal member 96 for partitioning the small diameter chamber 93 of the separation valve mechanism 90. In other words, the brake ECU 100 decreases the actual master cylinder pressure Pmc1_r for correction so that the actual master cylinder pressure Pmc1_r matches the master cylinder pressure Pmc1_d in the normal state corresponding to the stroke Sm1 represented by the signal acquired in Step S31, thereby acquiring the corrected master cylinder pressure Pmc1_a.

The brake ECU 100 acquires the corrected master cylinder pressure Pmc1_a in this way, and then proceeds to Step S33.

In Step S33, the brake ECU 100 uses the corrected master cylinder pressure Pmc1_a acquired by correcting the actual master cylinder pressure Pmc1_r in Step S32 to continue the brake control in the linear control mode described above. On this occasion, the corrected master cylinder pressure Pmc1_a is acquired by correcting the actual master cylinder pressure Pmc1_r by using the relationship between the master cylinder pressure Pmc1_d and the stroke Sm when the operations of the pressure increasing mechanism 80 and the separation valve mechanism 90 are normal and the servo pressure Ps having an appropriate magnitude is supplied. Therefore, regardless of the change in the servo pressure Ps, the driver can similarly sense the braking force generated in response to the stepping operation (namely, the stroke Sm) on the brake pedal 10. Thus, the driver does not feel a sense of discomfort for the stepping operation on the brake pedal 10, and can sense appropriate brake feeling.

As can be understood from the description given above, according to the embodiment, the stepped piston 92 can be used as the separation piston of the separation valve mechanism 90, and as a result, the forward/backward moving direction of the stepped piston 92 can be identified. With this, a content of an abnormality occurring in the separation valve mechanism 90, such as an abnormality in which the stepped piston 92 is stuck to the housing 91 and an abnormality in which the seal function by the seal member 95 or the seal member 96 is damaged, can be detected only by using the magnitude of the master cylinder pressure Pmc1 detected by the master cylinder pressure sensor 102 and the magnitude of the stroke Sm detected by the stroke sensor 104. Thus, an abnormality in the separation valve mechanism 90 can be extremely easily determined. Moreover, even when an abnormality occurs in the separation valve mechanism 90, the linear control mode for using the accumulator pressure Pacc by the power hydraulic pressure generation device 30 is continued by correcting the master cylinder pressure Pmc1 so that the degradation of the brake operation feeling can be made less insensible.

In the above-mentioned embodiment, the present invention is carried out so that the brake ECU 100 executes the above-mentioned abnormality determination program to determine a failure (abnormality) occurring in the servo system, more specifically, a content of an abnormality of the separation valve mechanism 90, and corrects the master cylinder pressure Pmc1_r depending on the determined abnormality content, thereby continuing the linear control mode. As a result, a failure (abnormality) occurring in the servo system, more specifically, the abnormality content in the separation valve mechanism 90 can be appropriately detected and identified, and the brake control is carried out by continuing the linear control mode, thereby appropriately restraining the brake operation feeling from degrading.

By the way, when the abnormality occurs in the seal function of the seal member 96 for partitioning the large diameter chamber 93 of the separation valve mechanism 90 among the abnormality contents of the separation valve mechanism 90 determined as described above, as illustrated in FIG. 9, the master cylinder pressure Pmc1 is supplied to the small diameter chamber 94 of the separation valve mechanism 90, and the stepped piston 92 then moves backward toward the large diameter chamber 93 and abuts against the housing 91. In this state, when the driver carries out the stepping operation on the brake pedal 10 and the master cylinder pressure Pmc 1 increases, as described above, the stepped piston 82 of the pressure increasing mechanism 80 moves forward by the master cylinder pressure Pmc1 supplied to the large diameter chamber 83 (small diameter chamber 94 of the separation valve mechanism 90) to a forward movement end position restricted by, for example, a stopper, and supplies the hydraulic pressure booster 21 with the servo pressure Ps.

In this case, when the stepped piston 82 of the pressure increasing mechanism 80 moves forward to the restricted forward movement end position, the stepped piston 92 of the separation valve mechanism 90 has moved backward so as to abut against the housing 91, and thus the volume in the small diameter chamber 94 does not increase. Therefore, a flowing-in amount of the working fluid which can be supplied from the master cylinder 22 via the master pressure pipe 11 to the separation valve mechanism 90 decreases, and the driver may feel a sense of discomfort for a change (increase) in the stepping force F input via the brake pedal 10, namely, a change (decrease) in the stroke Sm in the master cylinder 22.

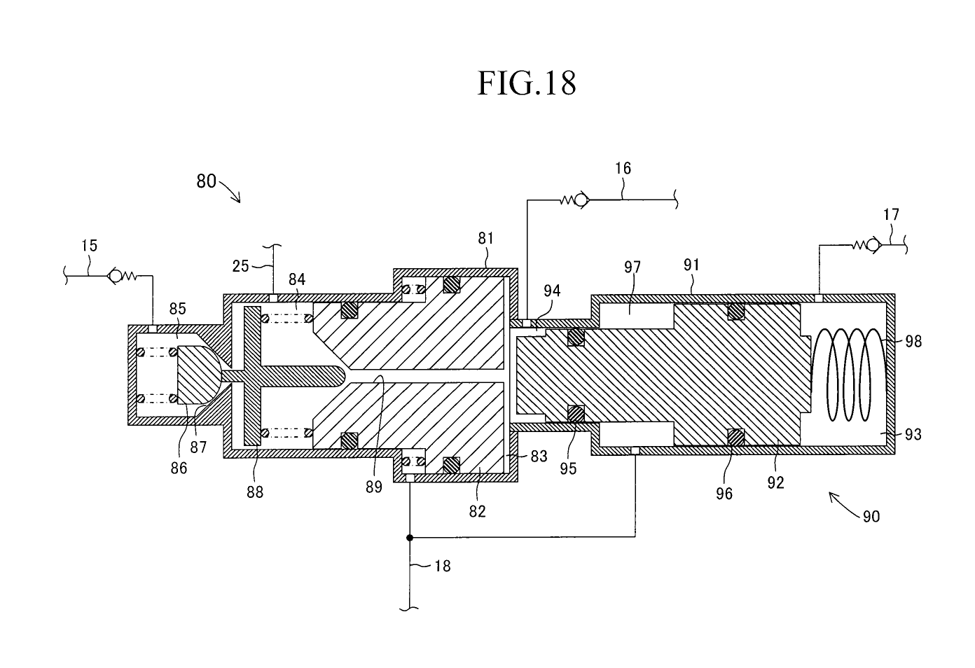

Therefore, as illustrated in FIG. 18, the present invention can be carried out by providing a stroke adjustment spring upon failure 98 as an elastic body between the end surface on the large diameter side of the stepped piston 92 and the inner wall surface of the housing 91 in the separation valve mechanism 90. As a result, even when an abnormality occurs in the seal function of the seal member 96 for partitioning the large diameter chamber 93 of the separation valve mechanism 90, the stroke Sm can be appropriately secured in the master cylinder 22. A specific description is now given of this modified example.

As described above, when an abnormality occurs in the seal function of the seal member 96 for partitioning the large diameter chamber 93 of the separation valve mechanism 90, even if the working fluid is supplied from the master pressure pipe 12 via the master pressure supply passage 17 to the large diameter chamber 93, the supplied working fluid flows out to the reservoir chamber 97, and hence the master cylinder pressure Pmc2 in the large diameter chamber 93 becomes “0”. Thus, when the working fluid (master cylinder pressure Pmc1) is supplied to the small diameter chamber 94, the stepped piston 92 moves backward to the large diameter chamber 93 by a pressure difference between the small diameter chamber 94 and the large diameter chamber 93.

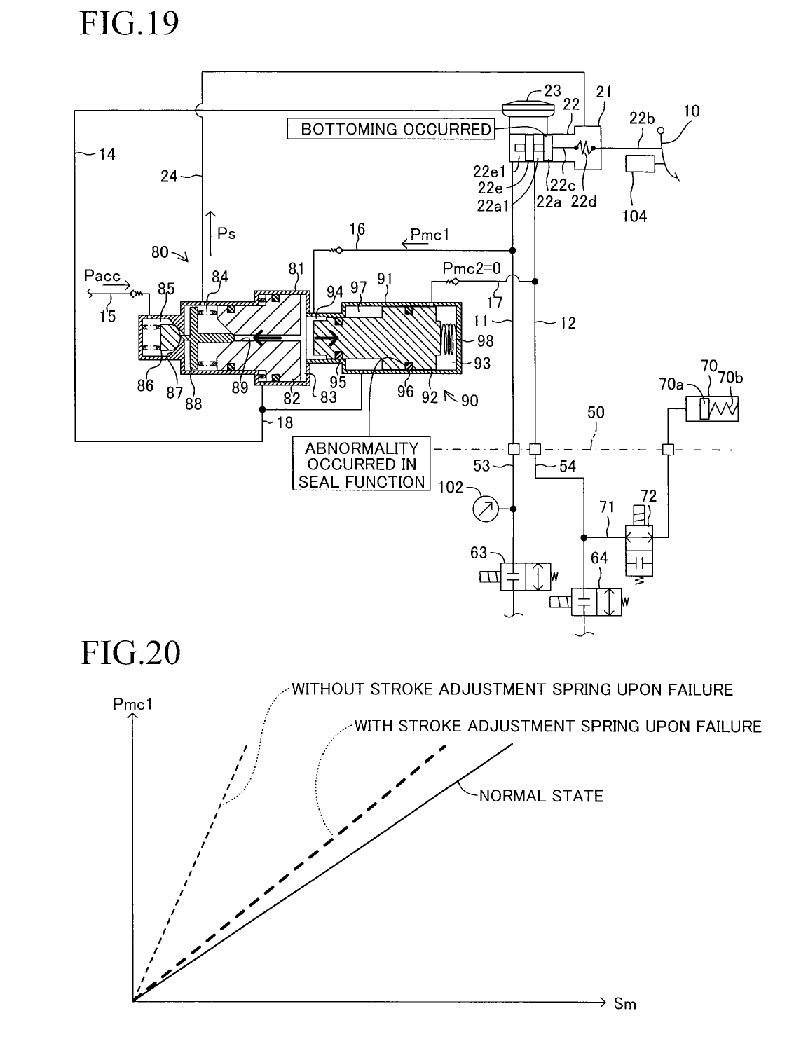

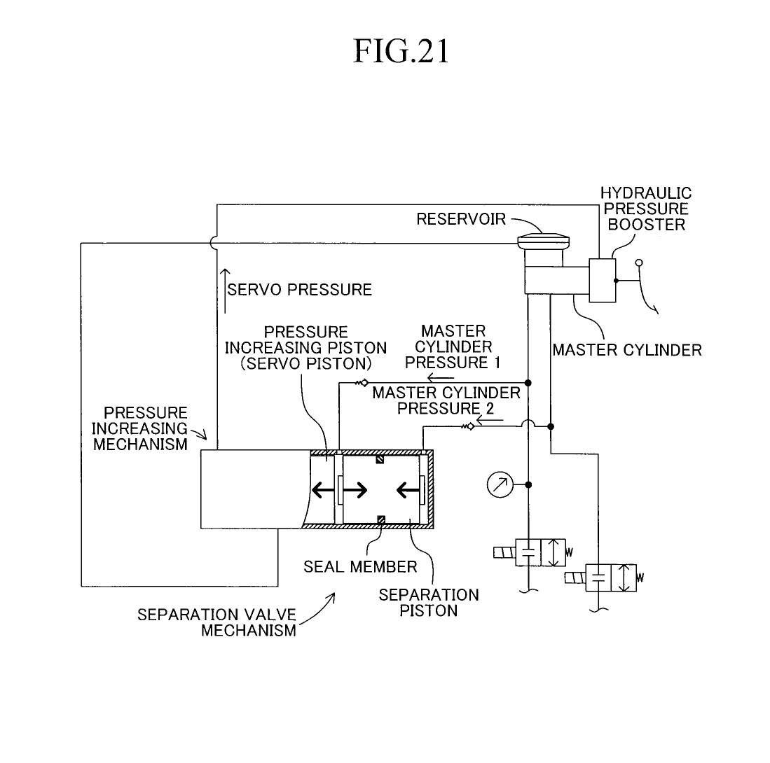

On this occasion, as illustrated in FIG. 19, when the stroke adjustment spring upon failure 98 is provided, the stepped piston 92 moves backward against a biasing force of the stroke adjustment spring upon failure 98, in other words, the stepped piston 92 can move backward while the pressing force (Pmc1×B1) caused by the master cylinder pressure Pmc1 supplied to the small diameter chamber 94 and the biasing force by the stroke adjustment spring upon failure 98 are balanced. In other words, as illustrated in FIG. 19, when the stroke simulator 70 is not connected to the master pressure pipe 11, the stepped piston 92 of the separation valve mechanism 90 and the stroke adjustment spring upon failure 98 can operate similarly to the piston 70a and the spring 70b of the stroke simulator 70.

Thus, the backward movement operation of the stepped piston 92 in a case where an abnormality occurs in the seal function of the seal member 96 for partitioning the large diameter chamber 93 of the separation valve mechanism 90 can be gently carried out by appropriately setting the spring constant of the stroke adjustment spring upon failure 98. As a result, even when an abnormality occurs in the seal function of the seal member 96 for partitioning the large diameter chamber 93 in the separation valve mechanism 90, the volume of the small diameter chamber 94 can be successively increased, in other words, as shown in FIG. 20, the stroke Sm in the master cylinder 22 can be appropriately secured so as to approach the stroke Sm in the normal state. As described above, the stroke Sm can be caused to approach the stroke Sm in the normal state by providing the stroke adjustment spring upon failure 98 in the separation valve mechanism 90, and hence even if a failure (abnormality) occurs in the servo system, the brake operation feeling can be appropriately restrained from degrading.

In carrying out the present invention, the present invention is not limited to the above-mentioned embodiment and modified example, and different kinds of changes can be made thereto without departing from an object of the present invention.

For example, in the above-mentioned embodiment and modified example, the present invention is carried out on the assumption that the hydraulic pressure booster 21 is a hydro booster which uses the servo pressure Ps (hydraulic pressure) supplied from the pressure increasing mechanism 80. In this case, any pressure increasing mechanism can be employed as the pressure increasing mechanism as long as the pressure increasing mechanism is capable of operating by the forward/backward movement of the stepped piston 92 of the separation valve mechanism 90, which separates the master cylinder pressures Pmc1 and Pmc2 from each other, and introducing the servo pressure Ps into the neighborhood of the stroke adjustment spring 22d for coupling the first piston rod 22b and the second piston rod 22c of the master cylinder 22 to each other, thereby appropriately boosting (amplifying) the stepping force F input by the driver via the brake pedal 10.

Moreover, in the above-mentioned embodiment and modified example, the present invention is carried out by forming the stroke adjustment spring 22d with use of the spring, which is an elastic body. Moreover, in the above-mentioned modified example, the present invention is carried out by forming the stroke adjustment spring upon failure 98 with use of the spring, which is an elastic body. In these cases, it should be understood that the present invention can be carried out by employing, as the elastic body, a member such as a rubber member other than the spring.

1. A vehicle brake device, comprising:
a wheel cylinder for receiving a hydraulic pressure of a working fluid and applying a braking force to a wheel;
a master cylinder for generating a hydraulic pressure in response to an operation by a driver on a brake pedal, and outputting the hydraulic pressure via a plurality of systems;
a power hydraulic pressure source for generating a hydraulic pressure through drive of a pressurizing pump;
a linear control valve for adjusting the hydraulic pressure transmitted from the power hydraulic pressure source to the wheel cylinder;
hydraulic pressure detection means for detecting a hydraulic pressure output from at least one of the plurality of systems of the master cylinder; and
control means for controlling drive of the linear control valve based on the hydraulic pressure detected by the hydraulic pressure detection means, wherein:
the master cylinder is configured to introduce therein a servo pressure generated in response to the brake pedal operation by the driver; and
the servo pressure to be introduced into the master cylinder is supplied from a pressure increasing mechanism connected to a separation valve mechanism,
the separation valve mechanism comprising a separation piston for separating and inputting hydraulic pressures output for each system from the master cylinder, the separation piston having pressure receiving areas different for each system, and being configured to mechanically move forward and backward depending on the input hydraulic pressure,
the pressure increasing mechanism being configured to mechanically move by at least one of a hydraulic pressure output from the at least one of the plurality of systems of the master cylinder whose hydraulic pressure is detected by the hydraulic pressure detection means or a pressing force by the forward movement of the separation piston of the separation valve mechanism, to thereby generate a hydraulic pressure having a certain ratio with respect to the hydraulic pressure output from the master cylinder.

2. A vehicle brake device according to claim 1, wherein:
the master cylinder is configured to output the hydraulic pressure in response to the brake operation by the driver with use of two systems;
the separation piston of the separation valve mechanism is configured so that a pressure receiving area for one of the two systems of the master cylinder is smaller than a pressure receiving area for another of the two systems of the master cylinder; and
the pressure increasing mechanism is configured to mechanically operate by at least one of a hydraulic pressure output from the one of the two systems of the master cylinder or the pressing force by the forward movement of the separation piston of the separation valve mechanism, to thereby generate the hydraulic pressure having the certain ratio with respect to the hydraulic pressure output from the master cylinder.

3. A vehicle brake device according to claim 1, wherein:
the separation valve mechanism further comprises:
a housing for storing the separation piston; and
a plurality of seal members provided between an outer peripheral surface of the separation piston and an inner peripheral surface of the housing, for separating the hydraulic pressures output for each system of the master cylinder from one another; and
the separation valve mechanism has a space into which the hydraulic pressure output from the master cylinder is prevented from entering by the plurality of seal members, the space communicating to a reservoir that is connected to the master cylinder and stores the working fluid, the space being partitioned by the outer peripheral surface of the separation piston, the inner peripheral surface of the housing, and the plurality of seal members, and being adjacent to spaces in which the hydraulic pressures output from the master cylinder for each system are input.

4. A vehicle brake device according to claim 1, wherein the separation valve mechanism further comprises an elastic body for adjusting a stroke of the separation piston configured to mechanically move forward and backward depending on the hydraulic pressures output for each system from the master cylinder.

5. A vehicle brake device according to claim 4, wherein the elastic body adjusts the stroke when the separation piston moves backward in a direction separating from the pressure increasing mechanism.

6. A vehicle brake device according to claim 1, further comprising stroke detection means for detecting a magnitude of a stroke input to the master cylinder in response to the operation by the driver on the brake pedal,
wherein the control means determines whether or not an abnormality occurs in the separation valve mechanism based on a magnitude of the hydraulic pressure output from the master cylinder and detected by the hydraulic pressure detection means and the magnitude of the stroke detected by the stroke detection means.

7. A vehicle brake device according to claim 6, wherein the control means determines that, based on a relationship between the hydraulic pressure output from the master cylinder and the stroke input to the master cylinder, which is satisfied in a normal state where no abnormality occurs in the separation valve mechanism, when a difference value between the magnitude of the hydraulic pressure output from the master cylinder in the normal state and the magnitude of the hydraulic pressure output from the master cylinder and detected by the hydraulic pressure detection means with respect to the magnitude of the stroke detected by the stroke detection means is larger than a predetermined value, such an abnormality occurs that the separation piston of the separation valve mechanism is stuck to the housing forming the separation valve mechanism and storing the separation piston, and the pressure increasing mechanism is mechanically operated only by the hydraulic pressure supplied from the master cylinder.

8. A vehicle brake device according to claim 6, wherein the control means determines that, in a state where an ineffective stroke which does not increase the magnitude of the hydraulic pressure output from the master cylinder and detected by the hydraulic pressure detection means with respect to an increase in the magnitude of the stroke detected by the stroke detection means is increasing, when the magnitude of the hydraulic pressure output from the master cylinder and detected by the hydraulic pressure detection means does not tend to increase, such an abnormality occurs that a seal function of the seal member provided between the housing, which forms the separation valve mechanism and stores the separation piston, and the separation piston, for separating the hydraulic pressures output for each system of the master cylinder from each other, is damaged, and the pressure increasing mechanism is mechanically operated only by the pressing force by the forward movement of the separation piston of the separation valve mechanism.

9. A vehicle brake device according to claim 6, wherein the control means determines that, in a state where an ineffective stroke which does not increase the magnitude of the hydraulic pressure output from the master cylinder and detected by the hydraulic pressure detection means with respect to an increase in the magnitude of the stroke detected by the stroke detection means is increasing, when the magnitude of the hydraulic pressure output from the master cylinder and detected by the hydraulic pressure detection means tends to increase, such an abnormality occurs that a seal function of the seal member provided between the housing, which forms the separation valve mechanism and stores the separation piston, and the separation piston, for separating the hydraulic pressures output for each system of the master cylinder, is damaged, and the pressure increasing mechanism is mechanically operated only by the hydraulic pressure supplied from the master cylinder.

10. A vehicle brake device according to claim 6, wherein when the control means determines that an abnormality occurs in the separation valve mechanism, the control means is configured to:
correct the magnitude of the hydraulic pressure output from the master cylinder and detected by the hydraulic pressure detection means by increasing the magnitude, based on a relationship between the hydraulic pressure output from the master cylinder and the stroke input to the master cylinder, which is satisfied in a normal state where no abnormality occurs in the separation valve mechanism, until the magnitude matches the magnitude output from the master cylinder in the normal state; and
use the increased and corrected magnitude of the hydraulic pressure output from the master cylinder to continue the drive control for the linear control valve.

11. A vehicle brake device according to claim 1, wherein:
in the master cylinder, a piston rod for coupling a pressurizing piston for pressurizing the stored working fluid and the brake pedal is divided;
the piston rod comprises:
a first piston rod connected to the brake pedal at one end;
a second piston rod connected to the pressurizing piston at one end; and
an elastic body for coupling another end of the first piston rod and another end of the second piston rod to each other, and adjusting a stroke caused by the operation by the driver on the brake pedal; and
the servo pressure is introduced from the pressure increasing mechanism to at least the pressurizing piston and the another end of the first piston rod.
